(19) United States
(12) Patent Application Publication
(10) Pub. No.: US 2009/0213431 A1
(43) Pub. Date: Aug. 27, 2009

(54) METHOD FOR OBTAINING CORRECTION VALUE, LIQUID EJECTING DEVICE

(75) Inventor: Toru Miyamoto, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/372,061

(22) Filed: Feb. 17, 2009

(30) Foreign Application Priority Data
Feb. 15, 2008 (JP) 2008-034816

(51) Int. Cl. G06K 15/00

(52) U.S. Cl. 358/3.03

(57) ABSTRACT

A method for obtaining a correction value including: forming a first test pattern configured to include a plurality of pixel rows, each of which has a plurality of pixels arrayed in a predetermined direction, arrayed in a direction crossing the predetermined direction; obtaining a first read gray-scale value for every pixel row by making a scanner read the first test pattern; calculating a first correction value for every pixel row on the basis of the first read gray-scale value; forming a second test pattern, which is configured to include the pixel rows arrayed in the crossing direction, using the first correction value; obtaining a second read gray-scale value for every pixel row by making the scanner read the second test pattern; calculating a correction amount for every pixel row on the basis of the first read gray-scale value and the second read gray-scale value; and calculating a second correction value of the certain pixel row on the basis of the correction amount of the pixel row and the correction amount of the pixel row adjacent to the pixel row.

### BACKGROUND OF THE INVENTION

1. Field of the Invention

The present invention relates to a method of obtaining a correction value and a liquid ejecting method.

2. Description of Related Applications

As a liquid ejecting device, an ink jet printer (hereinafter, a printer) that ejects ink from a nozzle is known. In such a printer, there is a possibility that an ink droplet may not land at a right position on a medium and the density unevenness may occur due to problems, such as machining accuracy of nozzles. For this reason, gray-scale values expressed by pixels are corrected such that an image piece viewed light is printed dark and an image piece viewed dark is printed light.

However, even though nozzles corresponding to a certain pixel piece are the same, if nozzles corresponding to image pieces adjacent to the image piece are different, the density of the image piece also changes. Accordingly, a method of correcting the density unevenness on the basis of a correction value for every image piece is proposed (refer to Patent Document 1).

[Patent Document 1] JP-A-2006-305952

### SUMMARY OF THE INVENTION

However, in the above density correcting method, the correction effects of density unevenness are not sufficient. For example, when ink ejected from nozzles corresponding to a certain image piece are deflected in flight, the image piece is viewed light. In this case, even if the amount of ink ejected from nozzles corresponding to the image piece is increased such that the image piece is printed dark, the correction effects of the image piece are not sufficient because the ink deviates from the image piece and lands. Therefore, in the present invention, it is an object to further improve the density unevenness.

The main invention for solving the problems is a method for obtaining a correction value including: a step of forming a first test pattern configured to include a plurality of pixel rows, each of which has a plurality of pixels arrayed in a predetermined direction, arrayed in a direction crossing the predetermined direction; a step of obtaining a first read gray-scale value for every pixel row by making a scanner read the first test pattern; a step of calculating a first correction value for every pixel row on the basis of the first read gray-scale value; a step of forming a second test pattern, which is configured to include the pixel rows arrayed in the crossing direction, using the first correction value; a step of obtaining a second read gray-scale value for every pixel row by making the scanner read the second test pattern; a step of calculating a correction amount for every pixel row on the basis of the first read gray-scale value and the second read gray-scale value; and a step of calculating a second correction value of the certain pixel row on the basis of the correction amount of the pixel row and the correction amount of the pixel row adjacent to the pixel row.

Other features of the present invention will be apparent by description of this specification and accompanying drawings.

### BRIEF DESCRIPTION OF THE DRAWINGS

FIG. 1 is a block diagram of the entire configuration of a printer.

FIG. 2A is a perspective view of a printer, and

FIG. 2B is a cross-sectional view of the printer.

FIG. 3 is an explanatory view showing the arrangement of nozzles on a bottom surface of a head.

FIG. 4 is a flow of print data creation processing.

FIG. 5 is an explanatory view of normal printing.

FIG. 6 is an explanatory view of front end printing and rear end printing.

FIG. 7A is a view in which dots are ideally formed, FIG. 7B is a view in which density unevenness occurred, and FIG. 7C is a view in which the density unevenness is corrected.

FIGS. 8A and 8B are views showing the situation of density unevenness correction of a comparative example.

FIG. 9 is a view of density correction when adjacent dots overlap each other.

FIG. 10 is a view showing the situation of density unevenness correction of the present embodiment.

FIG. 11 is a calculation flow of a density correction value.

FIG. 12A is a view showing a first test pattern, and FIG. 12B is a view showing a correction pattern.

FIG. 13A is a measured value table in which first read gray-scale values are summarized, and FIG. 13B is a view showing a reading result in a graph.

FIGS. 14A and 14B are views showing a calculation method of a first correction value.

FIG. 15 is a view showing a specific calculated value of a second correction value in a first example.

FIG. 16 is a view showing test pattern results and correction results.

FIG. 17 is a second correction value table.

FIG. 18 is a view showing a correction method in case where a gray-scale value before correction is different from a command gray-scale value.

FIG. 19 is a view showing a specific calculated value of a second correction value in a second example.

FIG. 20 is a view showing test pattern results and correction results.

FIG. 21 is a view showing a specific calculated value of a second correction value in a third example.

FIG. 22 is a view showing test pattern results and correction results.

### DESCRIPTION OF REFERENCE NUMERALS

1: printer
10: controller
11: interface portion
12: CPU
13: memory
14: unit control circuit
20: transport unit
21: paper feed roller
22: transport roller
23: paper discharge roller
30: carriage unit
31: carriage
40: head unit
41: head
50: detector group
60: computer

### DETAILED DESCRIPTION OF PREFERRED MODES

### Best Mode for Carrying Out the Invention

### Summary of Disclosure

At least the following things will be apparent by description of this specification and description of the accompanying drawings.

That is, a method for obtaining a correction value including: a step of forming a first test pattern configured to include a plurality of pixel rows, each of which has a plurality of pixels arrayed in a predetermined direction, arrayed in a direction crossing the predetermined direction; a step of obtaining a first read gray-scale value for every pixel row by making a scanner read the first test pattern; a step of calculating a first correction value for every pixel row on the basis of the first read gray-scale value; a step of forming a second test pattern, which is configured to include the pixel rows arrayed in the crossing direction, using the first correction value; a step of obtaining a second read gray-scale value for every pixel row by making the scanner read the second test pattern; a step of calculating a correction amount for every pixel row on the basis of the first read gray-scale value and the second read gray-scale value; and a step of calculating a second correction value of the certain pixel row on the basis of the correction amount of the pixel row and the correction amount of the pixel row adjacent to the pixel row is realized.

According to such a method for obtaining a correction value, correction of a pixel row, which is insufficiently corrected only by adjusting the amount of liquid ejected from nozzles corresponding to the pixel row, such as a pixel row (or a row region which is a region on paper corresponding to a pixel row) to which nozzles deflected in flight correspond or a pixel row influenced by adjacent pixel rows, can be complemented by liquid ejected from nozzles corresponding to adjacent pixel rows. Accordingly, the correction effects can be increased. For example, when liquid is ink, a correction value that improves the density unevenness of an image piece formed in each pixel row is obtained.

In such a method for obtaining a correction value, in the step of calculating the second correction value, a part of the correction amount of each of the pixel rows is distributed to an adjacent pixel row adjacent to each of the pixel rows, and the second correction value of the pixel row is calculated on the basis of the correction amount obtained by adding the correction amount of the certain pixel row and the correction amount distributed from the adjacent pixel row.

According to such a method for obtaining a correction value, correction of a pixel row, which is insufficiently corrected only by adjusting the amount of liquid ejected from nozzles corresponding to the pixel row, can be complemented by adjacent pixel rows.

In such a method for obtaining a correction value, correction effects of the first correction value are calculated for every pixel row on the basis of a target read gray-scale value, the first read gray-scale value, and the second read gray-scale value of the pixel row, and the correction amount distributed to the adjacent pixel row changes with the correction effects.

According to such a method for obtaining a correction value, it is possible to perform complementing using adjacent pixel rows by a correction amount, which is insufficient in correction performed only by adjusting the amount of liquid ejected from nozzles corresponding to the pixel row. Since the correction effects change with each pixel row, the correction effects can be further increased by determining the distributed amount on the basis of the correction effects.

In such a method for obtaining a correction value, a distance between landing positions of liquid droplets, which are ejected from nozzles corresponding to the adjacent pixel row adjacent to one side of the certain pixel row, and the pixel row is compared with a distance between landing positions of liquid droplets, which are ejected from nozzles corresponding to the adjacent pixel row adjacent to the other side of the pixel row, and the pixel row and the correction amount is distributed more to the adjacent pixel row corresponding to the shorter distance.

According to such a method for obtaining a correction value, since the amount of liquid ejected from nozzles corresponding to the adjacent pixel row in which liquid droplets land at closer positions of the certain pixel row largely affects the pixel row, the correction effects can be further increased by distributing a large correction amount.

Furthermore, a liquid ejecting method includes: a step of forming a first test pattern configured to include a plurality of pixel rows, each of which has a plurality of pixels arrayed in a predetermined direction, arrayed in a direction crossing the predetermined direction; a step of obtaining a first read gray-scale value for every pixel row by making a scanner read the first test pattern; a step of calculating a first correction value for every pixel row on the basis of the first read gray-scale value; a step of forming a second test pattern, which is configured to include the pixel rows arrayed in the crossing direction, using the first correction value; a step of obtaining a second read gray-scale value for every pixel row by making the scanner read the second test pattern; a step of calculating a correction amount for every pixel row on the basis of the first read gray-scale value and the second read gray-scale value; a step of calculating a second correction value of the certain pixel row on the basis of the correction amount of the pixel row and the correction amount of the pixel row adjacent to the pixel row; and a step of correcting a gray-scale value expressed by the pixel using the second correction value and ejecting liquid onto a medium.

According to such a liquid ejecting method, liquid can be ejected on the basis of a correction value that increases the correction effects of a pixel row, which is insufficiently corrected only by adjusting the amount of liquid ejected from nozzles corresponding to the pixel row.

Furthermore, there is provided a program causing a computer to realize: a function of forming a first test pattern configured to include a plurality of pixel rows, each of which has a plurality of pixels arrayed in a predetermined direction, arrayed in a direction crossing the predetermined direction; a function of obtaining a first read gray-scale value for every pixel row by making a scanner read the first test pattern; a function of calculating a first correction value for every pixel row on the basis of the first read gray-scale value; a function of forming a second test pattern, which is configured to include the pixel rows arrayed in the crossing direction, using the first correction value; a function of obtaining a second read gray-scale value for every pixel row by making the scanner read the second test pattern; a function of calculating a correction amount for every pixel row on the basis of the first read gray-scale value and the second read gray-scale value; and a function of calculating a second correction value of the certain pixel row on the basis of the correction amount of the pixel row and the correction amount of the pixel row adjacent to the pixel row.

According to such a program, it is possible to obtain a correction value that increases the correction effects of a pixel row, which is insufficiently corrected only by adjusting the amount of liquid ejected from nozzles corresponding to the pixel row.

Furthermore, there is provided a liquid ejecting device in which a correction value is stored, a gray-scale value expressed by a pixel of image data to be printed is corrected by the correction value and liquid is ejected on the basis of the corrected gray-scale value, and the correction value is obtained by: forming a first test pattern configured to include a plurality of pixel rows, each of which has a plurality of pixels arrayed in a predetermined direction, arrayed in a direction crossing the predetermined direction; obtaining a first read gray-scale value for every pixel row by making a scanner read the first test pattern; calculating a first correction value for every pixel row on the basis of the first read gray-scale value; forming a second test pattern, which is configured to include the pixel rows arrayed in the crossing direction, using the first correction value; obtaining a second read gray-scale value for every pixel row by making the scanner read the second test pattern; a step of calculating a correction amount for every pixel row on the basis of the first read gray-scale value and the second read gray-scale value; and calculating a second correction value of the certain pixel row on the basis of the correction amount of the pixel row and the correction amount of the pixel row adjacent to the pixel row.

### ===Regarding an Ink Jet Printer===

Hereinafter, an embodiment will be described using an ink jet printer as a liquid ejecting device and using a serial type printer (printer 1) among ink jet printers as an example.

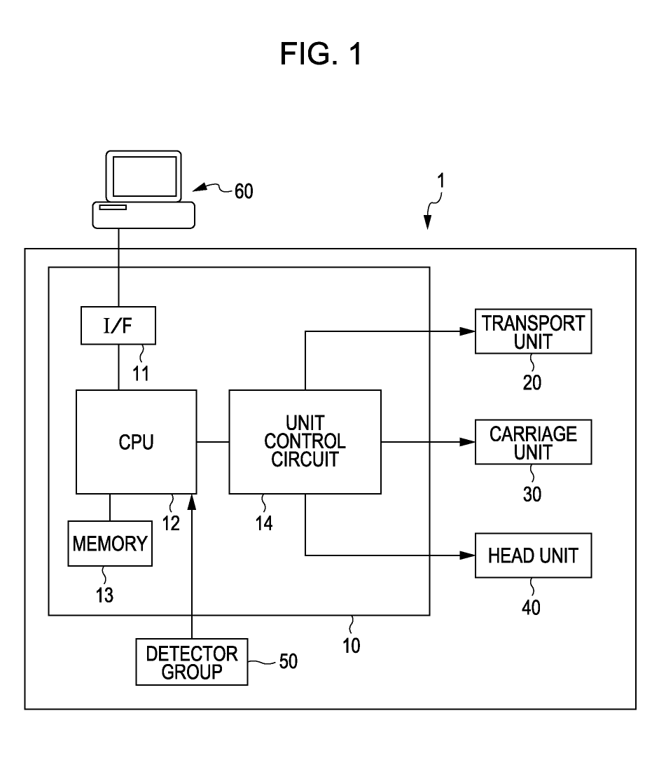

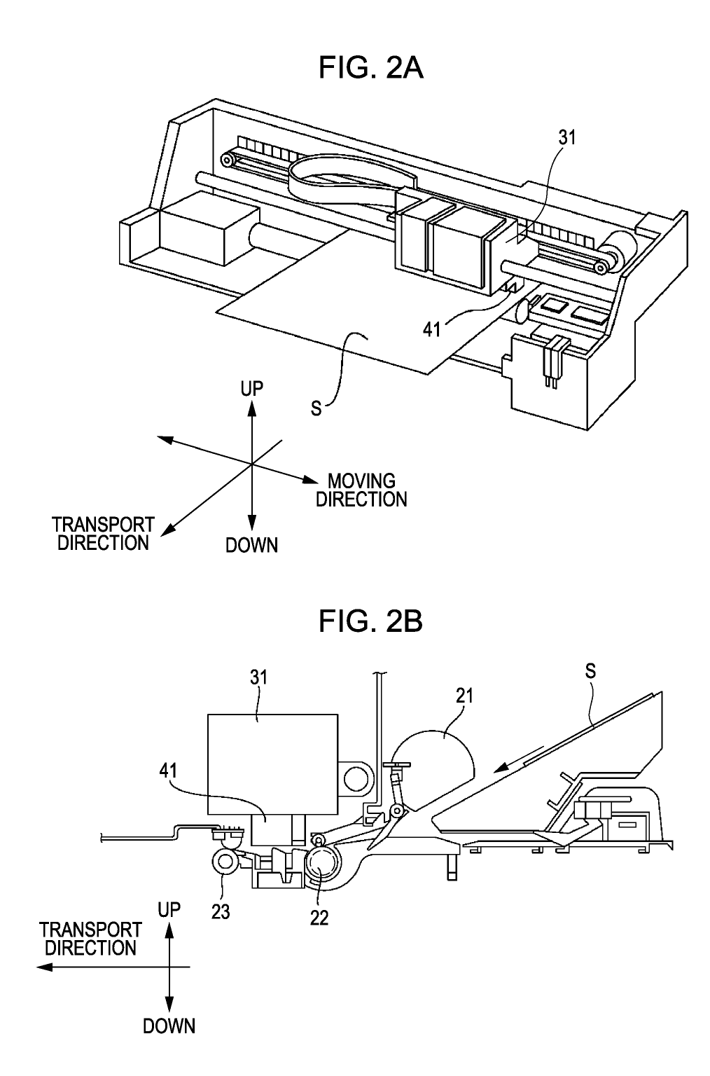

FIG. 1 is a block diagram of the entire configuration of the printer 1 of the present embodiment. FIG. 2A is a part of a perspective view of the printer 1, and FIG. 2B is a part of a cross-sectional view of the printer 1. The printer 1 that has received print data from a computer 60, which is an external apparatus, controls each unit (a transport unit 20, a carriage unit 30, and a head unit 40) by using a controller 10 and forms an image on paper S (medium). In addition, a detector group 50 monitors a situation in the printer 1, and the controller 10 controls each unit on the basis of the detection result.

The controller 10 is a control unit for controlling the printer 1. An interface portion 11 serves to perform transmission and reception of data between the printer 1 and the computer 60 that is an external apparatus. The CPU 12 is a processing unit for making an overall control of the printer 1. A memory 13 serves to secure a region for storing a program of the CPU 12, a working area, and the like. The CPU 12 controls each unit by a unit control circuit 14.

The transport unit 20 serves to send the paper S to the printable position and then transport the paper S by a predetermined transport amount in the transport direction at the time of printing. A paper feed roller 21 is rotated and the paper S to be printed is fed to a transport roller 22. When the paper S is positioned at a printing start position, at least some nozzles of a head 41 face the paper S. The paper S on which printing is completed is discharged by a paper discharge roller 23.

The carriage unit 30 serves to move the head 41 in a direction (hereinafter, called a moving direction) crossing the transport direction by a carriage 31.

The head unit 40 serves to discharge ink onto the paper S. A plurality of nozzles that are ink ejecting portions are provided on the bottom surface of the head 41. In each nozzle, an ink chamber (not shown) in which ink is filled and a driving element (piezoelectric element) for ejecting ink by changing the capacity of the ink chamber are provided.

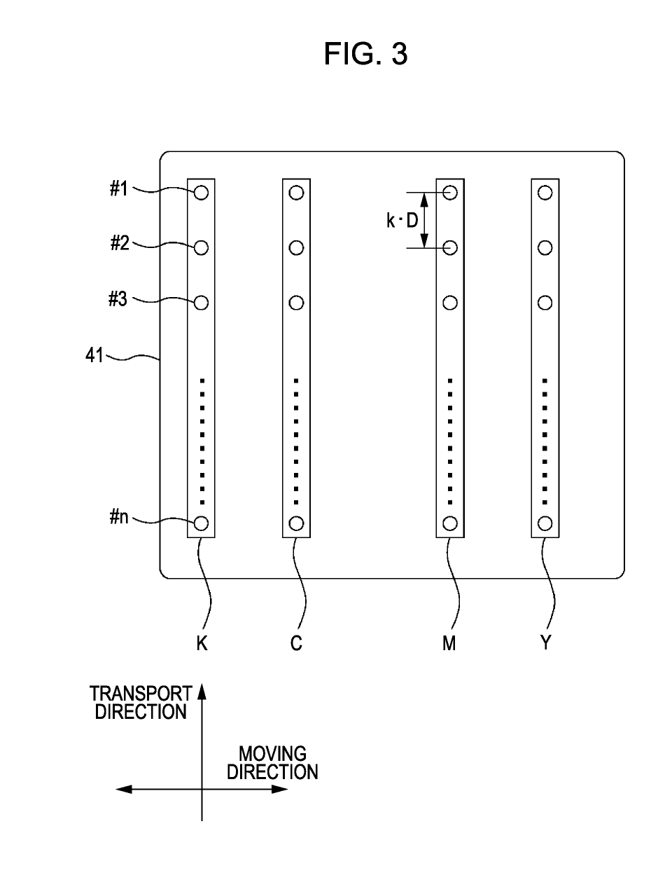

FIG. 3 is an explanatory view showing the arrangement of nozzles on a bottom surface (nozzle surface) of the head 41. A yellow ink nozzle row Y, a black ink nozzle row K, a cyan ink nozzle row C, and a magenta ink nozzle row M are formed on the bottom surface of the head 41. Each nozzle row has 180 nozzles, and a small number is given to a downstream-side nozzle (#i=#1-#180). In addition, nozzles of each nozzle row are arrayed at fixed distances k·D therebetween along the transport direction.

The serial type printer 1 continuously ejects ink from the head 41 moving along the moving direction and alternately repeats dot forming processing for forming dots on the paper S and transport processing for transporting the paper S in the transport direction such that a dot is formed at the position different from the position of a dot formed by the previous dot forming processing, thereby completing an image.

### ===Regarding Print Data===

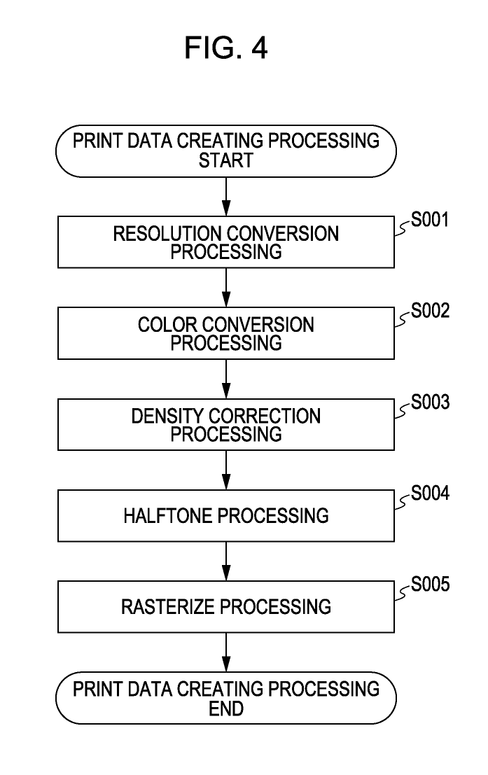

FIG. 4 is a flow of print data creation processing. Print data transmitted from the computer 60 to the printer 1 is created according to a printer driver stored in a memory of the computer 60. That is, the printer driver is a program for causing the computer 60 to create print data and transmitting the print data to the printer 1.

Resolution conversion processing (S001) is processing for converting image data output from an application program into the resolution at the time of printing on the paper S. When the resolution at the time of printing on the paper S is designated as 720×720 dpi, image data received from the application program is converted into image data with the resolution of 720×720 dpi. In addition, image data after the resolution conversion processing is 256 gray-scale data (RGB data) expressed by an RGB color space.

Here, image data is a group of pixel data, and pixel data is a gray-scale value that a pixel expresses. In addition, a pixel is a unit element that forms an image, and an image is formed by arraying pixels in a two-dimensional manner. ‘Image data is 256 gray-scale data’ means that one pixel is expressed in 256 gray-scale levels, and one pixel data is 8-bit data (2⁸=256). Moreover, in the present embodiment, it is assumed that the density of a region corresponding to the pixel increases as the gray-scale value increases.

Color conversion processing (S002) is processing for converting RGB data into CMYK data expressed by a CMYK color space corresponding to ink of the printer 1. This color conversion processing is performed when a printer driver refers to a table (not shown) in which a gray-scale value of RGB data is made to match a gray-scale value of CMYK data.

Density correction processing (S003) is processing for correcting a gray-scale value of each pixel data on the basis of a correction value corresponding to a row region to which the pixel data belongs. Details thereof will be described later.

Half tone processing (S004) is processing for converting data with a high gray-scale number into data with a gray-scale number that can be formed by the printer 1.

Rasterization processing (S005) is processing for rearranging matrix-shaped image data for every pixel data in order of data to be transmitted to the printer 1. Print data create through these processing is transmitted to the printer 1, by the printer driver, together with command data (transport amount and the like) according to a printing method.

### ===Regarding Interlace Printing===

It is assumed that the printer 1 of the present embodiment normally performs interlace printing. The interlace printing is a printing method in which between raster lines recorded in one pass, a raster line not recorded in the pass is inserted. In addition, a raster line is a dot row in which a plurality of dots are arrayed along the moving direction. In the interlace printing, a printing method at the start and end of printing is different from normal printing. Accordingly, an explanation will be made in a state where printing is divided into normal printing and front end printing and rear end printing.

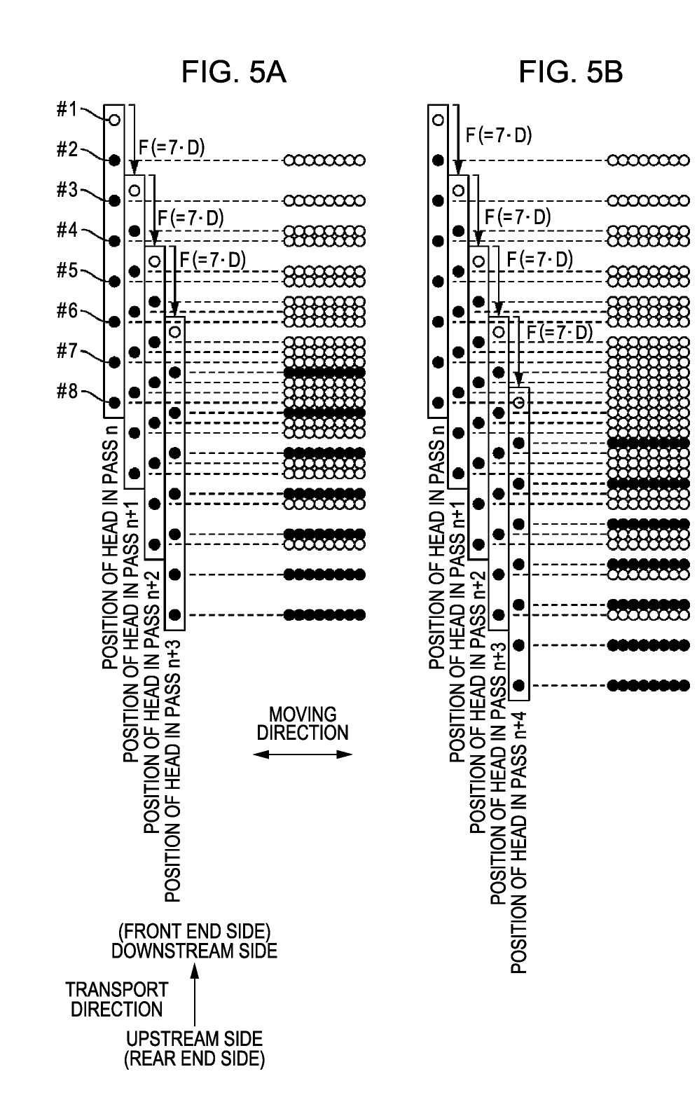

FIGS. 5A and 5B are explanatory views of normal printing. FIG. 5A shows the situation of the position of the head 41 and dot formation in passes n to n+3, and FIG. 5B shows the situation of the position of the head 41 and dot formation in passes n to n+4. For the convenience of explanation, only one nozzle row is shown and the number of nozzles in a nozzle row is also set small. In addition, although it is shown that the head 41 (nozzle row) moves with respect to the paper S, this drawing shows the relative positions of the head 41 and the paper S. In practice, the paper S moves in the transport direction. In this drawing, a nozzle shown by a black circle is a nozzle from which ink can be ejected and a nozzle shown by a white circle is a nozzle from which ink cannot be ejected. Moreover, in this drawing, a dot shown by a black circle is a dot formed in a last pass and a dot shown by a white circle is a dot formed in a pass therebefore.

In normal printing of interlace printing, whenever the paper S is transported by a fixed transport amount F in the transport direction, each nozzle records a raster line immediately above a raster line (at the front end side) recorded in a pass immediately therebefore. Conditions for performing recording in a state where the transport amount is fixed as described above are (1) the number N (integer) of nozzles from which ink can be ejected and k (nozzle gap k D) are relatively prime and (2) the transport amount F is set to N·D. Here, N=7, k=4, and F=7·D. However, in this case, there is a place where a raster line is not formed at the start and end of printing. For this reason, in front end printing and rear end printing, a printing method different from normal printing is performed.

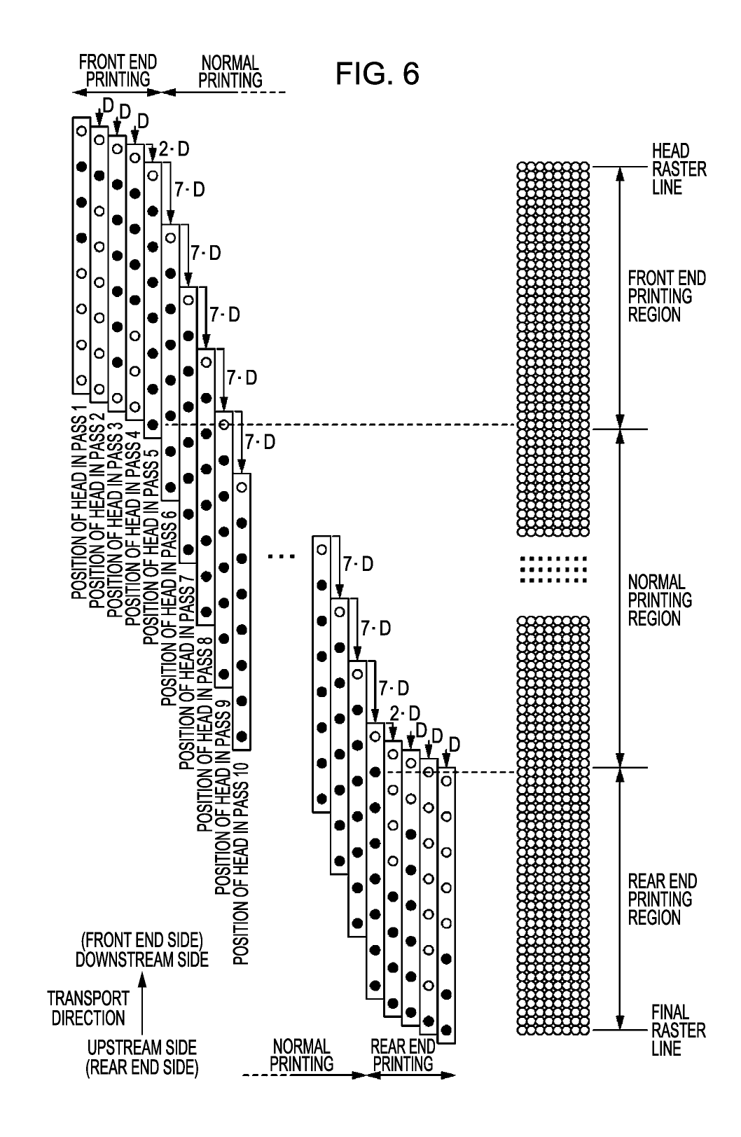

FIG. 6 is an explanatory view of front end printing and rear end printing. First five passes are front end printing and the last five passes are rear end printing. In the front end printing, the paper S is transported with a transport amount (1·D or 2·D) smaller than a transport amount (7·D) at the time of normal printing. Moreover, in the front end printing and the rear end printing, nozzles that eject ink therefrom are not fixed. Accordingly, a plurality of raster lines arrayed continuously in the transport direction may also be formed at the start and end of printing. In addition, 30 raster lines are formed in the front end printing and 30 raster lines are also formed in the rear end printing. On the other hand, in normal printing, thousands of raster lines are formed although it depends on the size of the paper S.

Moreover, in an arrangement method of raster lines in a region printed by normal printing (hereinafter, called a normal printing region), there are regularities for every raster lines the number of which is the same as the number (here, N=7) of nozzles from which ink can be ejected. In the normal printing, a raster line formed first to a seventh raster line are formed by nozzles #3, #5, #7, #2, #4, #6, and #8 and next seven raster lines from an eighth raster line are also formed by nozzles in the same order as those. On the other hand, in the arrangement of raster lines in a region printed by front end printing (hereinafter, called a front end printing region) and a region printed by rear end printing (hereinafter, called a rear end printing region), it is difficult to find out the regularities compared with the raster lines in the normal printing region.

### ===Regarding Density Unevenness ===

Here, a ‘pixel region’ and a ‘row region’ are set. The ‘pixel region’ refers to a rectangular region virtually set on the paper S, and the size thereof is determined according to the print resolution. One ‘pixel region’ on the paper S and one ‘pixel’ on image data correspond to each other. In addition, the ‘row region’ is a region formed by a plurality of pixel regions arrayed in the moving direction (equivalent to a predetermined direction). The ‘row region’ corresponds to a ‘pixel row’ in which a plurality of pixels on image data are arrayed along a direction corresponding to the moving direction.

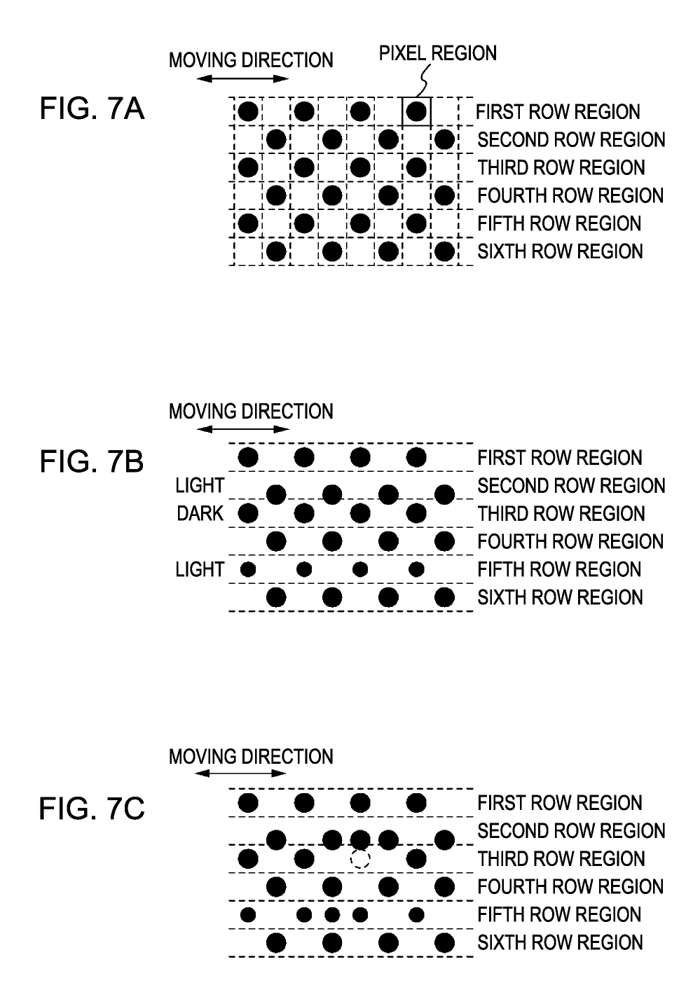

FIG. 7A is an explanatory view when a dot is formed ideally. Ideal forming of a dot means that a specified amount of ink droplets land on the center of a pixel region and a dot is formed.

FIG. 7B is an explanatory view when the density unevenness occurs. A raster line formed in a second row region is formed to lean to the third row region side by flight deflection of ink droplets ejected from nozzles. As a result, the second row region becomes light and the third row region becomes dark. On the other hand, the ink amount of ink droplets ejected onto a fifth row region is smaller than the specified amount, such that a dot formed in the fifth row region is small. As a result, the fifth row region becomes light.

When an image formed by row regions with such different densities is seen macroscopically, the density unevenness with a stripe shape along the moving direction of the carriage is viewed. The image quality of a printed image deteriorates due to the density unevenness. Therefore, in the present embodiment, it is an object to suppress the density unevenness.

### ===Regarding Density Unevenness Correction===

### Density Unevenness Correction in a Comparative Example

FIG. 7C is a view showing how the density unevenness of FIG. 7B is corrected. For density unevenness correction, gray-scale values of pixels corresponding to the row region are corrected such that a light image piece is formed in a row region viewed dark. In addition, gray-scale values of pixels corresponding to the row region are corrected such that a dark image piece is formed in a row region viewed light.

For example, in FIG. 7C, gray-scale values of pixels corresponding to each row region are corrected such that the generation rate of dots of the second and fifth row regions viewed light is increased and the generation rate of dots of the third row region viewed dark is decreased. In this way, the dot generation rate of each row region is changed, and the density of an image piece formed in each row region is corrected. As a result, the density unevenness of the entire printed image is suppressed.

In addition, in the case of a printer capable of forming dots with a plurality of sizes, the correction may be performed such that the diameter of a dot formed in a row region viewed light is increased and the diameter of a dot formed in a row region viewed dark is decreased.

That is, the density unevenness is suppressed by increasing the amount of ink ejected toward a row region viewed light and decreasing the amount of ink ejected toward a row region viewed dark. First, the density unevenness correction in the comparative example is shown below.

In FIG. 7B, the reason why the density of an image piece formed in the third row region is dark is not because of nozzles corresponding to the third row region but because of influences of nozzles corresponding to the adjacent second row region. Accordingly, when nozzles corresponding to the third row region form a raster line in another row region, an image piece formed in the row region does not necessarily become dark. That is, if nozzles that form adjacent image pieces are different even if it is an image piece formed by the same nozzle, the density may be different. In such a case, the density unevenness cannot be suppressed only with a correction value corresponding to the nozzle. Therefore, in the density unevenness correction of the comparative example, gray-scale values of pixels corresponding to each row region are corrected on the basis of a correction value set for every row region.

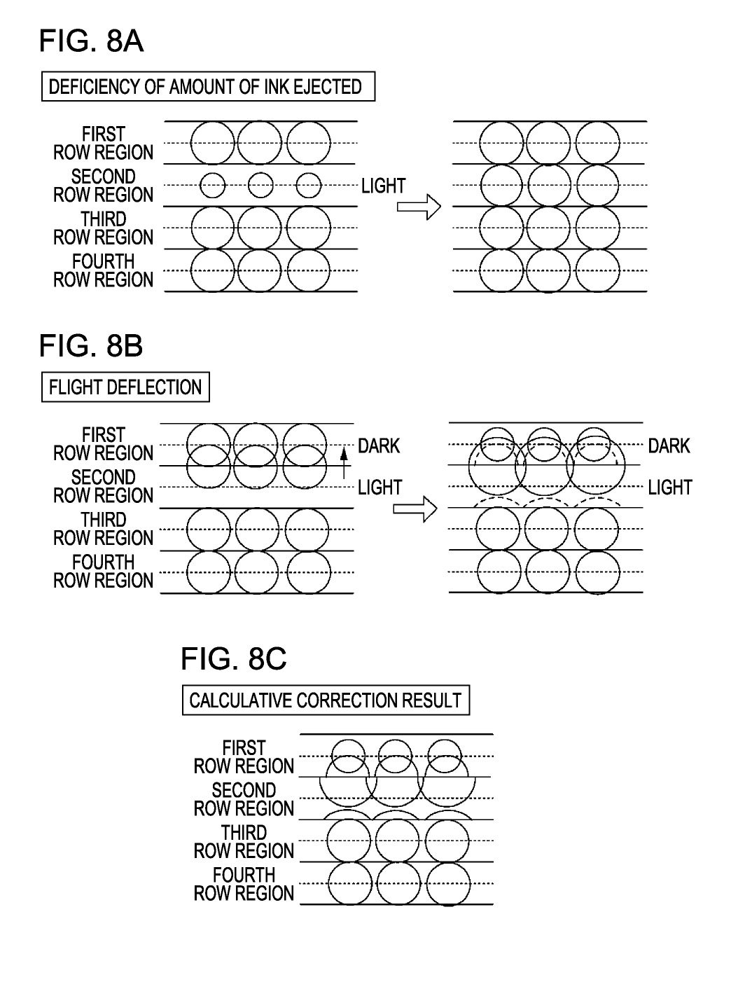

FIGS. 8A and 8B are views showing the situation of density unevenness correction of the comparative example based on a correction value for every row region. Moreover, in actual density correction processing, a gray-scale value of 256 gray scales expressed by each pixel is corrected and halftone processing is performed on the basis of the corrected gray-scale value (S004 of FIG. 4). For example, in the case where correction is performed such that the density becomes dark, if halftone processing is performed with a gray-scale value after correction, the dot generation rate is raised compared with a result in which the halftone processing is performed with a gray-scale value before correction. Or when dots with a plurality of sizes are formed, a probability that a dot with a large size will be formed increases. Hereinbelow, for the convenience of explanation, the situation of density correction using the difference in a dot diameter will be described.

FIG. 8A is a view showing correction of the density unevenness occurring due to variation in the amount of ink ejected. For example, it is supposed that ink less than the specified amount is ejected from nozzles corresponding to the second row region. In this case, dots formed in the second row region are smaller than dots formed in other row regions, and only the second row region is viewed light. Therefore, the correction is performed such that gray-scale values of pixels corresponding to the second row region are increased (gray-scale value are corrected to be viewed dark). For example, even if an instruction to form middle dots in first to fourth row regions is made, the middle dots formed in the second row region are smaller than the specified size. Accordingly, in the second row region, the gray-scale value is corrected such that a larger dot than the middle dot is formed.

In this way, larger dots than dots before correction are formed in the second row region. As a result, since a difference between the density of the second row region viewed light and the density of other row regions is reduced, the density unevenness is removed.

FIG. 8B is a view showing correction of density unevenness occurring due to flight deflection of ink droplets. If dots of the second row region are formed to lean to the first row region side, the first row region is viewed dark and the second row region is viewed light. Therefore, in the density unevenness correcting method of the comparative example, a gray-scale value of a pixel corresponding to the first row region is reduced so that the diameter of a dot formed in the first row region is decreased. On the other hand, a gray-scale value of a pixel corresponding to the second row region is raised so that the diameter of a dot formed in the second row region is increased.

FIG. 8C is a view showing a calculative correction result of density unevenness (FIG. 8B) caused by flight deflection. Computationally, the correction is performed such that the first row region is viewed light by making a dot of the first row region small by a portion, which is formed to lean to the first row region, of a dot before correction of the second row region. Then, the correction is performed such that the second row region viewed light becomes dark by making a dot of the second row region large by a portion, which is formed to lean to the first row region, of a dot of the second row region.

However, in practice, as shown in FIG. 8B, the correction effects obtained by making dots of the first row region small are decreased due to making large (dotted line->solid line) dots of the second row region formed to lean to the first row region. On the other hand, even if dots of the second row region are made to become large, the correction effects are not sufficient because parts of the dots made large are formed to lean to the first row region (because dotted portions of dots are not formed in the second row region).

That is, in the density correcting method of the comparative example, the density of a certain row region is corrected by only nozzles corresponding to the row region. Accordingly, in a row region corresponding to nozzles deflected in flight or a row region adjacent to the row region, there is a possibility that the effects of density correction will not be sufficient. That is, since the amount of ink ejected from nozzles deflected in flight has a small effect on a row region corresponding to the nozzles, the correction effects become insufficient compared with the calculative correction result (FIG. 8C) even if the density correction is performed only by the nozzle deflected in flight. In addition, in a row region adjacent to the row region corresponding to the nozzles deflected in flight, the correction effects are reduced due to the influence of dots formed by flight deflection.

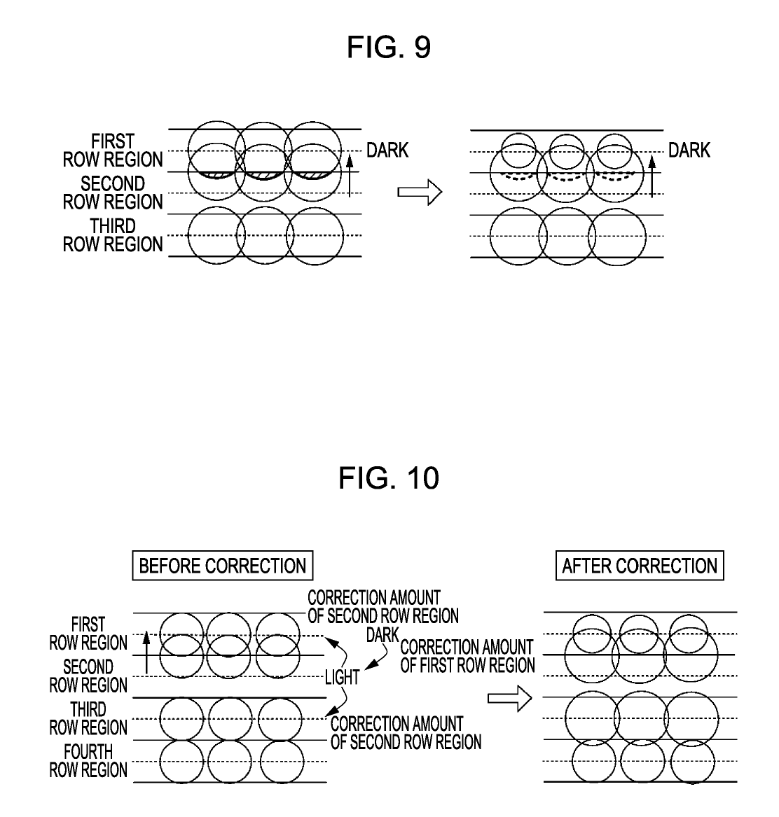

FIG. 9 is a view showing the situation of density correction when dots formed in adjacent row regions overlap each other. It is assumed that dots with the sizes enough to protrude from the row region are formed and parts of dots of the adjacent row region overlap the dots. In such a case, if dots formed in the adjacent row region become small, the density of the row region also becomes slightly light. For example, as shown in FIG. 9, dots of a second row region are formed to lean to the first row region side. At this time, since the first row region is viewed dark if a row region is corrected by only nozzles corresponding to the row region, the correction is performed such that the dot diameter is decreased. Since the second row region is viewed light, the correction is performed such that the dot diameter is increased. Then, paying attention to the second row region in the printing result after correction, a portion (diagonal line portion) of a dot of the first row region protruding toward the second row region disappears and the correction effects for making the second row region dark are reduced.

Thus, also in the case where dots formed in adjacent row regions overlap each other, there is a possibility that the correction effects will be reduced due to the influence of density correction of adjacent row regions.

Therefore, in the present embodiment, it is an object to raise the effects of density unevenness correction of a row region where the correction effects are reduced due to the influence of a row region corresponding to nozzles deflected in flight or an adjacent row region (it is an object to reduce a variation in the amount of liquid ejected for every row region). That is, in the present embodiment, it is an object to reduce the density unevenness more than in the density unevenness correcting method of the comparative example in which the density of a certain row region is corrected by only nozzles corresponding to the row region.

### Density Unevenness Correction in the Present Embodiment

FIG. 10 is a view showing the situation of density unevenness correction of the present embodiment. As a result of formation of dots of the second row region in a state of leaning to the first row region side, the first row region is viewed dark and the second row region is viewed light.

Paying attention to the second row region, it is viewed light in a state before correction because dots are deflected in flight. Therefore, in order that the second row region is viewed dark, correction is performed such that dots formed by nozzles corresponding to the second row region become large. However, performing only these things are the same as the density unevenness correcting method of the comparative example. The effects of density correction are not sufficient simply by making a dot formed by flight deflection large in the second row region. Therefore, in the present embodiment, a part of the correction amount of the second row region is also distributed to the first and third row regions. As a result, a large dot enough to protrude toward the second row region is formed in the third row region. In the correction method (FIG. 8B) of the comparative example, the correction effects of lightness of the second row region are low since correction is not performed such that a dot of the third row region becomes large. On the other hand, in the present embodiment, since the lightness of the second row region can be complemented by the dot of the third row region, the density unevenness can be improved more than the correction method of the comparative example.

In addition, paying attention to only the second row region, the correction is performed such that dots formed by nozzles corresponding to the second row region become large, but a part of the correction amount of adjacent first and third row regions is distributed to the second row region. Since the first row region is viewed dark, it is necessary to correct it to be viewed light. The correction amount for making the first row region light is distributed to the second row region. In addition, since there is no density difference between the third row region and other row regions, the correction amount distributed from the third row region to the second row region is zero. That is, dots of the second row region are formed on the basis of the correction amount for making the second row region dark and the correction amount for making the first row region light. As a result, the dots of the second row region are formed not to be too large compared with the comparative example (FIG. 8B) (or formed such that the dot generation rate does not become too high). In this way, it is possible to prevent the correction effects, by which dots become small such that the first row region is viewed light, from being reduced by dots of the second row region.

In addition, the correction amount of the second row region is also distributed to the first row region. In FIG. 10, it is shown that dots of adjacent row regions do not overlap in order to make a difference of dot diameters easily understood. However, in case of forming dots with sizes enough to protrude from the row region, dots of the first row region are formed not to be too small by distributing the correction amount of the second row region to the first row region. As a result, it is prevented that a portion of a dot of the first row region protruding to the second row region becomes too small, and it can be prevented that the correction effects for making the second row region dark are reduced.

By the way, ‘variation in the amount of ink ejected’ and ‘flight deflection of ink droplets’ may be considered as causes of occurrence of the density unevenness. It can be seen whether or not the density unevenness has occurred by actually printing a test pattern by a printer without performing the density correction processing. However, only by the test pattern on which the density correction processing has not been performed, it cannot be determined whether the cause of density unevenness is the variation in the amount of ink ejected or the flight deflection of ink droplets.

Therefore, in the present embodiment, it is checked whether or not the density unevenness has occurred by printing the first test pattern without performing density correction processing. When the density unevenness occurs, the density unevenness correction processing is performed with only nozzles corresponding to each row region like the density unevenness correction of the comparative example and the second test pattern is printed in order to check the cause of occurrence of the density unevenness. When the density unevenness is corrected as a result of the second test pattern, it is seen that the density unevenness occurs due to the ‘variation in the amount of ink ejected’ (for example, FIG. 8A). When correction of the density unevenness is not sufficient, it is seen that the density unevenness occurs due to the ‘flight deflection of ink droplets’ or the effects of density unevenness correction are reduced due to the influence of adjacent row regions (for example, FIG. 8B). In such a case, since correction of density unevenness is not sufficient only with nozzles corresponding to the row region, the correction amount is distributed to adjacent row regions and density correction processing is performed.

Specifically, a first correction value H1 is set for every row region on the basis of the density (first read gray-scale value) for every row region of the first test pattern on which the density correction processing is not performed. The first correction value H1 is a correction value for adjusting the amount of ink ejected from nozzles corresponding to a certain row region in order to perform the density correction of the row region. Then, the density (second read gray-scale value) for every row region of a second test pattern on which the density correction processing is performed using the first correction value H1 is obtained.

Then, the second test pattern is evaluated. In order to do so, a density (second read gray-scale value) for every row region of the second test pattern is compared with a target value (for example, Cbt) calculated on the basis of the first read gray-scale value. In the case of a row region where there is no difference between the second read gray-scale value and the target value, it is thought that the density unevenness was corrected by the first correction value H1.

On the other hand, in the case of a row region where there is a difference between the second read gray-scale value and the target value, it is thought that density correction using the first correction value H1 is not sufficient. Accordingly, a part of the correction amount of the row region is distributed to adjacent row regions. That is, density correction of a certain row region is performed on dots of the row region and dots of a row region adjacent to the row region. In other words, the final density correction value (hereinafter, called a second correction value H2) of each row region is calculated on the basis of the correction amount of the row region and the correction amount of a row region (corresponding to an adjacent pixel row) adjacent to the row region. As a result, the density unevenness can be further reduced.

Hereinafter, a calculation method (first to third examples) of a density correction value will be described in detail.

### Calculation Method of a Density Correction Value

### First Example

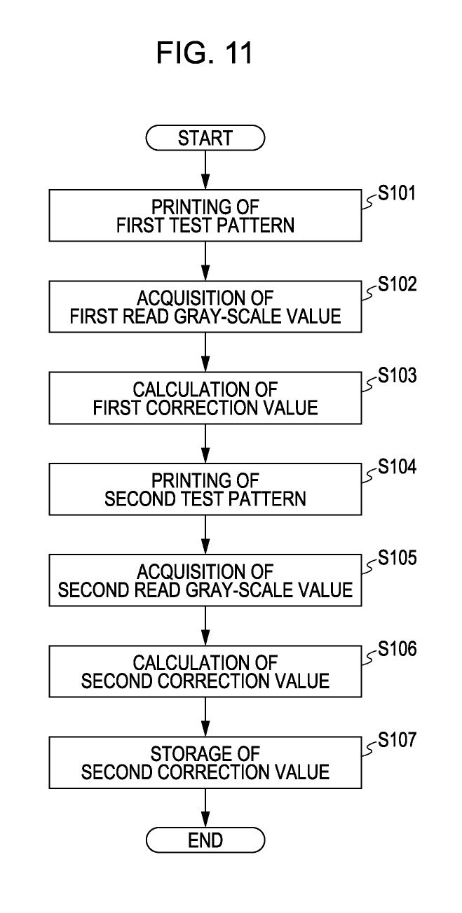

FIG. 11 is a calculation flow (flow of a method for obtaining a correction value) of a density correction value (second correction value H2). In the present embodiment, the second correction value H2 for every printer is obtained in an inspection process after manufacturing of a printer. Moreover, in order to obtain the second correction value, the target printer 1 and a scanner (not shown) are connected to the computer 60. A printer driver for causing the printer 1 to print a test pattern, a scanner driver for controlling a scanner, and a correction value obtaining program for obtaining a second correction value on the basis of image data of a test pattern read from the scanner are installed beforehand in the computer 60.

### <S101: Printing of a First Test Pattern>

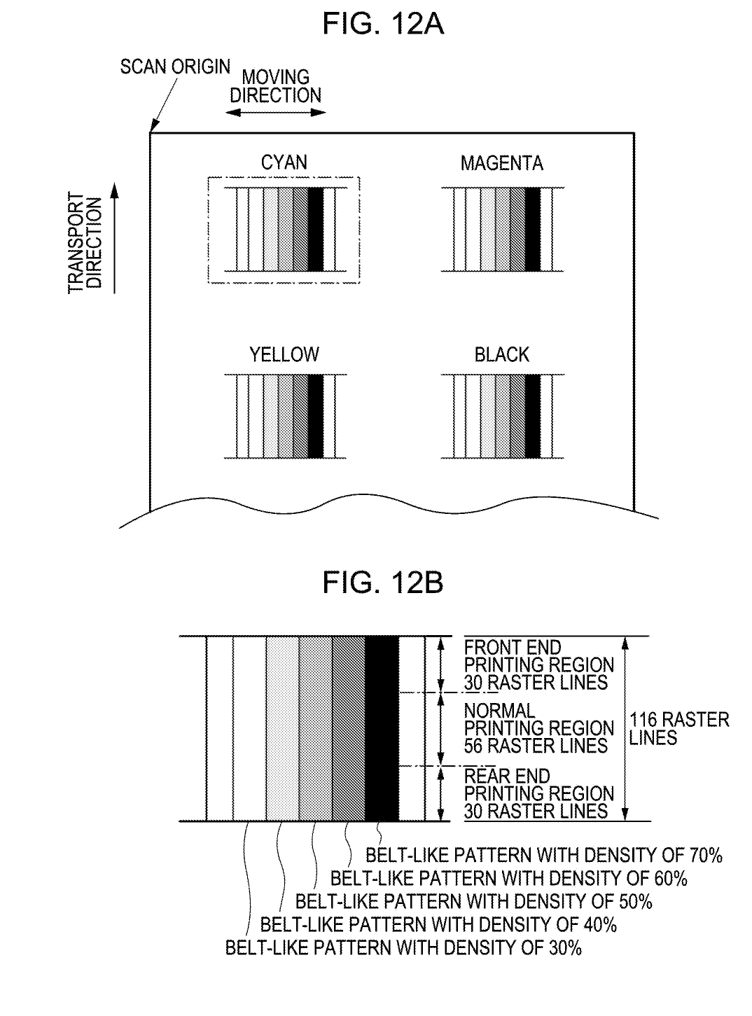

FIG. 12A is a view showing the first test pattern, and FIG. 12B is a view showing a correction pattern. The printer driver of the computer 60 causes the printer 1 to print a test pattern shown in FIG. 12A.

The first test pattern is configured to include four correction patterns formed for every nozzle row with different colors (cyan, magenta, yellow, and black). Each correction pattern is configured to include belt-like patterns with five kinds of density. Each belt-like pattern is generated from image data with a fixed gray-scale value. A gray-scale value of a belt-like pattern is called a command gray-scale value. A command gray-scale value of a belt-like pattern with a density of 30%, a command gray-scale value of a belt-like pattern with a density of 40%, a command gray-scale value of a belt-like pattern with a density of 50%, a command gray-scale value of a belt-like pattern with a density of 60%, and a command gray-scale value of a belt-like pattern with a density of 70% are expressed as Sa(76), Sb(102), Sc(128), Sd(153), and Se(178), respectively.

In addition, each belt-like pattern is configured to include 30 raster lines based on front end printing, 56 raster lines based on normal printing, and 30 raster lines based on rear end printing. That is, it can be said that a belt-like pattern is configured to include 116 row regions (pixel rows) arrayed in the transport direction (equivalent to a crossing direction).

### <S102: Acquisition of a First Read Gray-Scale Value>

Next, the printed first test pattern is read by the scanner. For example, as shown in FIG. 12A, it is preferable that the upper left of paper on which the first test pattern is printed be set as the origin of the scanner and a range (one-dotted chain line) surrounding a correction pattern of cyan be set as a reading range. Similarly, correction patterns formed by other nozzle rows are also read. When an image (range of a one-dotted chain line) of the read correction pattern is inclined, the inclination θ of the image is detected and rotation processing corresponding to the inclination θ is performed on image data.

On the image data of the correction pattern, it is assumed that a region corresponding to a ‘pixel region’ of the correction pattern is a ‘pixel’ and a region corresponding to a ‘row region’ is a ‘pixel row (pixel row in which a plurality of pixels are arrayed in a direction corresponding to the moving direction)’. In addition, unnecessary pixels of the image data read in a larger range (range of the one-dotted chain line) than the correction pattern is trimmed. Then, the number of pixels in the direction equivalent to the transport direction is made to be equal to the number (number of row regions) of raster lines of the correction pattern. That is, the pixel row and the row region are made to correspond to each other in a one-to-one manner. For example, a pixel row located uppermost corresponds to a first row region and a pixel row located therebelow corresponds to a second row region.

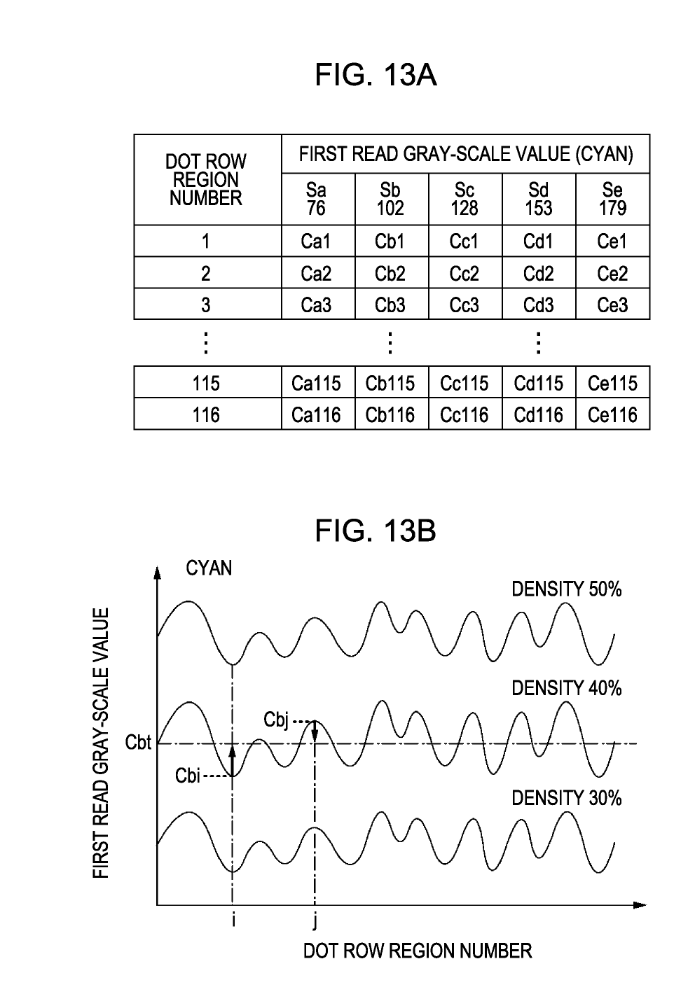

FIG. 13A is a measured value table in which reading results (first read gray-scale values) of five kinds of belt-like patterns of cyan are summarized, and FIG. 13B is a view showing reading results of belt-like patterns with the density of 30% to 50% in a graph. After making a pixel row and a row region correspond to each other in a one-to-one manner, the density of each row region is calculated for every belt-like pattern. An average value of read gray-scale values of each pixel of a pixel row corresponding to a certain row region is assumed to be a first read gray-scale value of the row region. As a result, a first read gray-scale value of each row region is calculated for each of the five kinds of belt-like patterns, as shown in FIG. 13A. In addition, the first read gray-scale value of the first row region of the belt-like pattern with a density of 30% (Sa) of cyan is expressed as Cal, and the first read gray-scale value of the second row region of the belt-like pattern with a density of 50% (Sc) of cyan is expressed as Cc2.

In FIG. 13B showing the reading result of a correction pattern in the graph, a horizontal axis is a row region number and a vertical axis is a first read gray-scale value. As shown in the graph, a variation occurs in the first read gray-scale value for every row region even though each belt-like pattern is uniformly formed by each command gray-scale value. For example, according to the graph of FIG. 13B, it is seen that an i-th row region is viewed light and a j-th row region is viewed dark compared with other row regions. The variation in density for every row region is a cause of the density unevenness of a printed image.

### <S103: Calculation of the First Correction Value H1>

In order to reduce the variation in density for every row region as shown in FIG. 13B, it is preferable to eliminate a variation in the density for every row region in the same gray-scale value. That is, the density unevenness is improved by bringing the density of each row region close to a fixed value.

Therefore, in the same command gray-scale value, for example, Sb, an average value Cbt of first read gray-scale values (Cb1 to Cb116) of all row regions is set as a ‘target value Cbt’. In addition, a gray-scale value of a pixel corresponding to each row region is corrected so that the first read gray-scale value of each row region in the command gray-scale value Sb is brought close to the target value Cbt.

In a row region i (Cbi) where a read gray-scale value is lower than the target value Cbt of cyan ink to the command gray-scale value Sb, the gray-scale value is corrected to be printed darker than setting of the command gray-scale value Sb. On the other hand, in a row region j (Cbj) where a read gray-scale value is higher than the target value Cbt, the gray-scale value is corrected to be printed lighter than setting of the command gray-scale value Sb.

Thus, in order to bring the densities of all row regions close to the fixed value (target value) for the same gray-scale value, a correction value for correcting a gray-scale value of a pixel corresponding to each row region is set to the first correction value H1. The first correction value H1 is calculated on the basis of a measurement result (first read gray-scale value) of the row region and is a correction value for correcting only a gray-scale value of a pixel corresponding to the row region.

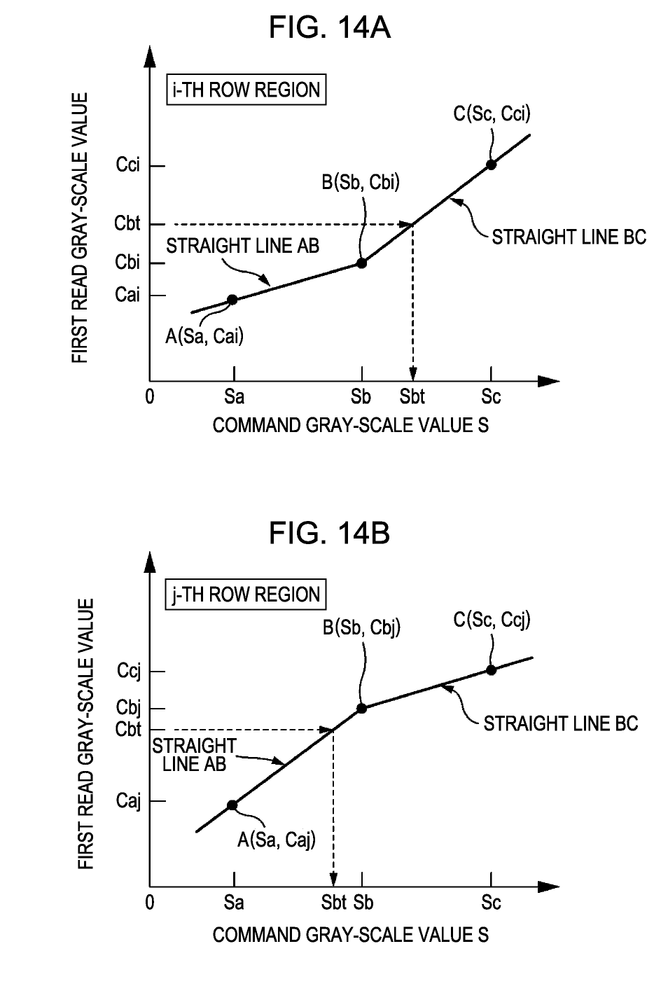

FIGS. 14A and 14B are views showing specific calculation methods of the first correction value H1 using a correction value obtaining program.

FIG. 14A is a view showing a calculation method of the target gray-scale value Sbt of the i-th row region where a reading result is lower than the target gray-scale value Cbt. A horizontal axis indicates a command gray-scale value, and a vertical axis indicates a first read gray-scale value. On the graph, a reading result (Cai, Cbi, Cci) of cyan of the i-th row region to the command gray-scale value (Sa, Sb, Sc) is plotted. The target command gray-scale value Sbt for making the i-th row region expressed with the target value Cbt for the command gray-scale value Sb is calculated by the following expression (linear interpolation based on a straight line BC).

Sbt=Sb+(Sc−Sb)×{(Cbt−Cbi)/(Cci−Cbi)}

FIG. 14B is a view showing a calculation method of the target gray-scale value Sbt of the j-th row region where a reading result is higher than the target gray-scale value Cbt. On the graph, a reading result of cyan of the j-th row region is plotted. The target command gray-scale value Sbt for making the j-th row region expressed with the target value Cbt for the command gray-scale value Sb is calculated by the following expression (linear interpolation based on a straight line AB).

Sbt=Sa+(Sb−Sa)×{(Cbt−Caj)/(Cbj−Caj)}

In this way, after calculating the target command gray-scale value Sbt for making the density of each row region expressed with the target value Cbt for the command gray-scale value Sb by the correction value obtaining program, a first correction value H1b for the command gray-scale value Sb of each row region is calculated by the following expression.

H1b=(Sbt−Sb)/Sb

Similarly, five first correction values (H1a, H1b, H1c, H1d, H1e) for five command gray-scale values (Sa, Sb, Sc, Sd, Se) are calculated for every row region. In addition, not only the first correction values for cyan but also first correction values of other nozzle rows are calculated.

In addition, 56 raster lines are printed in a normal printing region of a correction pattern of the present embodiment. In the normal printing region, there are regularities for every seven raster lines. Accordingly, seven first correction values are calculated on the basis of an average value of first read gray-scale values of total eight row regions for every seven raster lines.

### <S104: Printing of a Second Test Pattern>

When the five first correction values (H1a, H1b, H1c, H1d, H1e) are calculated for every nozzle row YMCK and every row region, density correction processing is performed using the first correction value H1 and the second test pattern is printed. The second test pattern forms four correction patterns for every nozzle row, similar to the first test pattern shown in FIG. 12A. Density correction processing on the command gray-scale values Sa to Se of five belt-like patterns is performed using the first correction value H1 for every row region, and the second test pattern is printed.

For example, a gray-scale value S_out after correction of the i-th row region of the belt-like pattern with a density of 30% (Sa) of cyan is expressed by the following expression. A first correction value of the i-th row region to the command gray-scale value Sa is set to ‘H1a_i’.

S_out=(1+H1a_{—}i)×Sa

In this way, the printer driver corrects the command gray-scale values Sa to Se for every row region using the first correction value H1 (S_out) and makes the second test pattern printed.

### <S105: Acquisition of a Second Read Gray-Scale Value>

Next, the second test pattern on which the density correction processing has been performed using the first correction value H1 is read by the scanner. Then, similar to the acquisition method of the first read gray-scale value (S102), an average value of read gray-scale values of pixels corresponding to each row region is calculated for every correction pattern YMCK and every belt-like pattern (density of 30% to 70%). The average value is set to the second read gray-scale value of each row region. For example, the second read gray-scale value of the first row of the belt-like pattern with a density of 30% (Sa) of cyan is expressed as ‘C′a1’, and the second read gray-scale value of the second row of the belt-like pattern with a density of 50% (Sc) of cyan is expressed as ‘C′c2’.

### <S106: Calculation of the Second Correction Value H2>

In the present embodiment, a second test pattern result (second read gray-scale value) is evaluated and it is determined whether or not the density correction has been made by the first correction value H1. If the effects of the density correction using the first correction value H1 are not sufficient (if there is a difference between the second read gray-scale value and the target value), the density correction is not sufficient only by adjusting the amount of ink ejected from nozzles corresponding to the row region. Accordingly, a part of the correction amount of the row region is distributed to adjacent row regions. That is, the second correction value H2 of the row region is calculated on the basis of the correction amount of the row region and the correction amount of row regions adjacent to the row region. Accordingly, density correction of the row region is performed by adjusting the amount of ink ejected toward the row region and the amount of ink ejected toward row regions adjacent to the row region.

In the first example, a part of the correction amount of a certain row region is uniformly distributed to row regions adjacent to the row region. Here, in a result of the second test pattern, for a row region where density correction is not sufficient, every 10% of the correction amount of the row region is distributed to adjacent row regions. In this way, the second correction value H2 of each row region is calculated on the basis of a correction amount obtained by adding the correction amount of the row region and a part (10%) of the correction amount of the adjacent row region sequentially from the first row region.

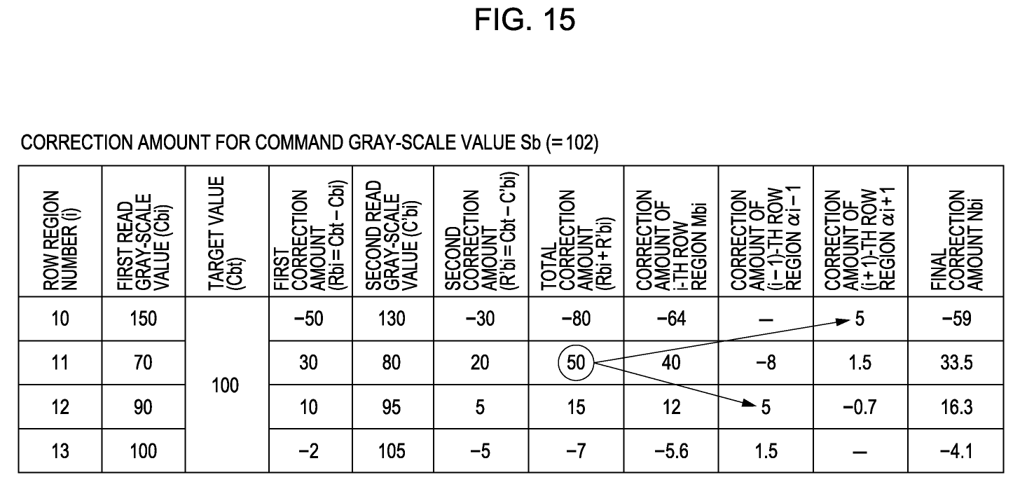

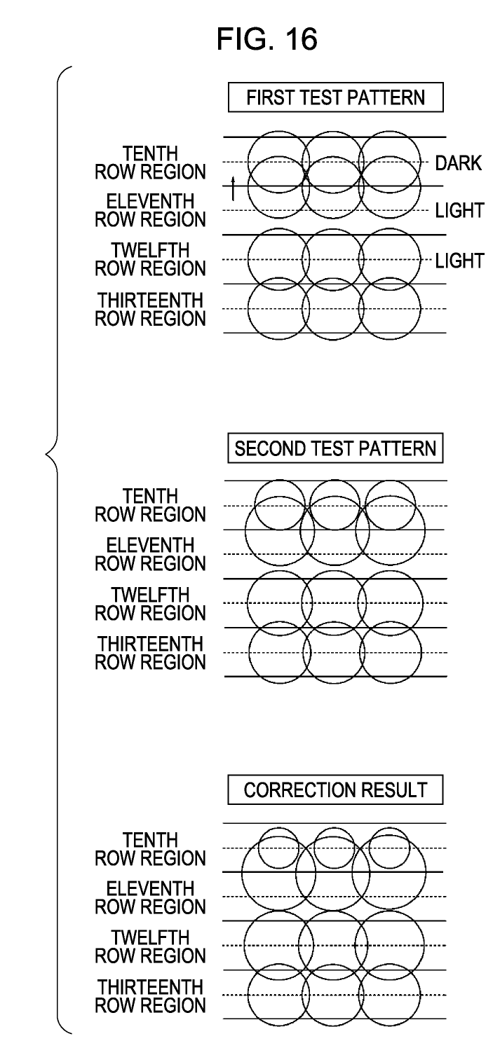

FIG. 15 is a view showing a specific calculated value of the second correction value H2 in the first example. FIG. 16 is a view showing first and second test pattern results and a result of density unevenness correction using the second correction value H2, which are based on values of FIG. 15. Hereinafter, the calculation method of the second correction value H2 in the first example will be described using specific values.

For explanation, some row regions (tenth to thirteenth row regions) of 116 row regions that form the belt-like pattern (Sb=102) with a density of 40% of cyan are mentioned as an example. Moreover, it is assumed that ink droplets from nozzles corresponding to the eleventh row region land to lean to the tenth row region. As a result, as shown in FIG. 16, dots of the eleventh row region are formed to lean to the tenth row region in the first test pattern on which density correction processing is not performed. Accordingly, the tenth row region is viewed dark. As shown in FIG. 15, the first read gray-scale value of the tenth row region to the command gray-scale value ‘102’ is set to ‘150’. On the other hand, the eleventh row region is viewed light and the first read gray-scale value of the eleventh row region to the command gray-scale value ‘102’ is set to ‘70’. In addition, it is assumed that dots of adjacent row regions overlap each other. Accordingly, the twelfth row region is viewed lighter than the command gray-scale value 102 as much as a portion, which does not protrude to the twelfth row region, of the dots of the eleventh row region deflected in flight, and the first read gray-scale value is set to ‘90’. In addition, these values are values set to clarify a difference in the density for every row region, and a difference between a command gray-scale value and a read gray-scale value and the like are set to larger values than actual values.

After obtaining the first read gray-scale value of each row region, a target value (average value of first read gray-scale values of all row regions) for each command gray-scale value is calculated. In addition, for the command gray-scale value (for example, Sb), the target gray-scale value (Sbt) for making each row region expressed with target value (Cbt) is calculated (FIG. 14). Moreover, as described above, the first correction value H1 is calculated on the basis of the command gray-scale value (Sb) and the target gray-scale value (Sbt).

Here, a target value of cyan to the command gray-scale value ‘Sb=102’ is set as ‘Cbt=100’, and a difference between the target value Cbt and the first read gray-scale value Cbi of the row region i is set as the first correction amount Rbi (=Cbt−Cbi). For example, the first correction amount Rb10 of the tenth row region is ‘−50’. The first correction amount ‘Rb10=−50’ indicates that the density unevenness is eliminated if the tenth row region i is expressed light by the ‘gray-scale value 50’ for the command gray-scale value Sb. On the other hand, the first correction amount ‘Rb11=30’ of the eleventh row region indicates that the density unevenness is eliminated if the eleventh row region i is expressed dark by the ‘gray-scale value 30’ for the command gray-scale value Sb.

In addition, according to the second test pattern on which the density processing was performed using the first correction value H1 (FIG. 16), the dot diameter in the tenth row region becomes small such that the tenth row region is expressed light by the first correction amount ‘Rb10=50’. On the other hand, the dot diameter in the eleventh row region becomes large such that the eleventh row region is expressed dark by the first correction amount ‘Rb11=30’.

However, the correction effects obtained by making the dot diameter of the tenth row region small are reduced due to making the dot diameter of the eleventh row region large. Therefore, for the target value Cbt=100, a result of the density correction becomes not sufficient such that the second read gray-scale value of the tenth row region in the second test pattern is set as C′b10=130.

Furthermore, since dots of the eleventh row region are formed by flight deflection even though the dot diameter is made large, the effects on the row region are low. Therefore, for the target value Cbt=100, a result of the density correction becomes not sufficient such that the second read gray-scale value of the eleventh row region in the second test pattern is set as C′b11=80.

In addition, in order to evaluate the second test pattern result obtained by performing density correction processing with the first correction value H1, a second correction amount R′bi (=Cbt−C′bi) that is a difference between the target value Cbt and the second read gray-scale value C′bi is calculated.

For example, the second correction amount Rb10 of the tenth row region is ‘−30’. This is a result in which the effects of density correction are reduced due to the influence of dots of the eleventh row region deflected in flight even though the density correction processing was performed by the first correction value H1.

In addition, the second correction amount Rb11 of the eleventh row region is ‘20’. This is a result in which the effects on the row region are low due to flight deflection of dots even though density correction processing was performed with nozzles corresponding to the row region by the first correction value H1.

Thus, when the density correction effects of a certain row region are not sufficient (that is, in the case of the second correction amount R′bi≠0) as a result (second test pattern) after performing density correction processing with the first correction value H1, 10% of the correction amount of the row region is distributed to row regions adjacent to the row region. The correction amount of the row region is set as a total correction amount (Rbi+R′bi) of the first correction amount Rbi when density correction is not performed and the second correction amount R′bi that could not be corrected even if the density correction was performed with the first correction value H1. In addition, in the case of the second correction amount R′bi=0, a part of the first correction amount Rbi of the i-th row region may be distributed to adjacent row regions or may not be distributed. Moreover, when the second correction amount R′bi of the i-th row region is 0, the correction amount of the (i−1)-th row region may be distributed only to the (i−2)-th row region and the amount of distribution of the (i+1)-th row region may be distributed only to the (i+2)-th row region without distributing to the i-th row region the amount of distribution of the (i−1)-th and (i+1)-th row regions adjacent to the i-th row region.

In addition, a final correction amount Nbi of the i-th row region is a total correction amount of Mbi which is 80% of the total correction amount of the i-th row region, a correction amount αi−1 distributed from the (i−1)-th row region, and a correction amount αi+1 distributed from the (i+1)-th row region.

For example, the total correction amount of the eleventh row region for the command gray-scale value Sb is ‘50 (=30+20)’. 80% ‘40 (=50×0.8)’ of the total correction amount of the eleventh row region is corrected by the eleventh row region itself, and 10% ‘5 (=50×0.1)’ of the total correction amount of the eleventh row region is distributed to twelfth and thirteenth row regions. In addition, the final correction amount Nbi of the eleventh row region becomes a value obtained by summing up the correction amount Mbi=40 of the row region, αi−1=−8 which is the correction amount of 10% of total correction amount of the tenth row region −80, and αi+1=1.5 which is the correction amount of 10% of total correction amount 15 of the twelfth row region.

The second correction value H2 is calculated on the basis of the final correction amount Nbi.

For example, for the command gray-scale value Sb, a target gray-scale value S′bt corresponding to ‘target value Cbt+final correction amount Nbi’ is calculated such that each row region i is expressed with the target value Cbt. Then, a ‘second correction value H2b=(S′bt−Sb)/Sb’ is calculated on the basis of the target gray-scale value S′bt.

As shown in FIG. 15, since the correction result of the first test pattern was not sufficient in the tenth row region, the final correction amount Nbi ‘−59’ is larger than the first correction amount Rbi ‘−50’. That is, in a correction result obtained by performing density correction on the basis of the second correction value H2 (final correction amount Nbi) rather than the second test pattern on which the density correction was performed on the basis of the first correction value H1 (first correction amount Rbi), small dots are formed in the tenth row region.

On the other hand, since the correction result of the first test pattern was not sufficient in the eleventh row region, the final correction amount Nbi ‘33.5’ is larger than the first correction amount Rbi ‘30’. However, since the correction amount ‘−8’ of 10% of the tenth row region is added, correction is performed such that dots do not become too large. Therefore, it can be prevented that the effects of correcting the density of the tenth row region light are reduced due to the influence of dots of the eleventh row region deflected in flight.

In addition, although it was suppressed that dots of the eleventh row region become large, the correction amount ‘5’ of 10% of the eleventh row region is distributed to the twelfth row region. Therefore, in the twelfth row region, dots whose correction result is larger than the second test pattern are formed, and the lightness of the eleventh row region can be complemented.

Thus, in the present embodiment, when density correction is not sufficient only with the amount of ink from nozzles corresponding to the row region, the density correction is also performed by the amount of ink from nozzles corresponding to adjacent row regions. Accordingly, when nozzles corresponding to the row region are deflected in flight, the density is complemented by adjacent row regions. In addition, even when the effects of density correction are reduced due to the influence of adjacent row regions, a reduction in the effects of density correction can be prevented since a part of correction amount of the row region is distributed to the adjacent row regions. As a result, the density unevenness can be further improved.

If the effects of density correction are not sufficient in the result of the second test pattern, correction is performed again only by nozzles corresponding to the row region like density unevenness correction of the comparative example. For example, in the result of the second test pattern of FIG. 16, correction effects of the tenth and eleventh row regions are not sufficient. Accordingly, if correction is performed once again, dots of the tenth row region become smaller and dots of the eleventh row region become larger. Thus, only by repeating the density unevenness correction of the comparative example, the correction amount of the eleventh row region is not distributed to the twelfth row region and dots of the twelfth row region do not become large unlike the present embodiment. For this reason, the lightness of the density of the eleventh row region is not solved. In addition, since the correction amount of the tenth row region is not distributed to the eleventh row region, dots of the eleventh row region become too large. Therefore, the effects of density correction based on making dots of the tenth row region small are reduced. That is, distributing the correction amount of the row region to adjacent row regions like the present embodiment improves the density unevenness more than repeating density unevenness correction of the comparative example does.

### <S107: Regarding Storage of the Second Correction Value H2>

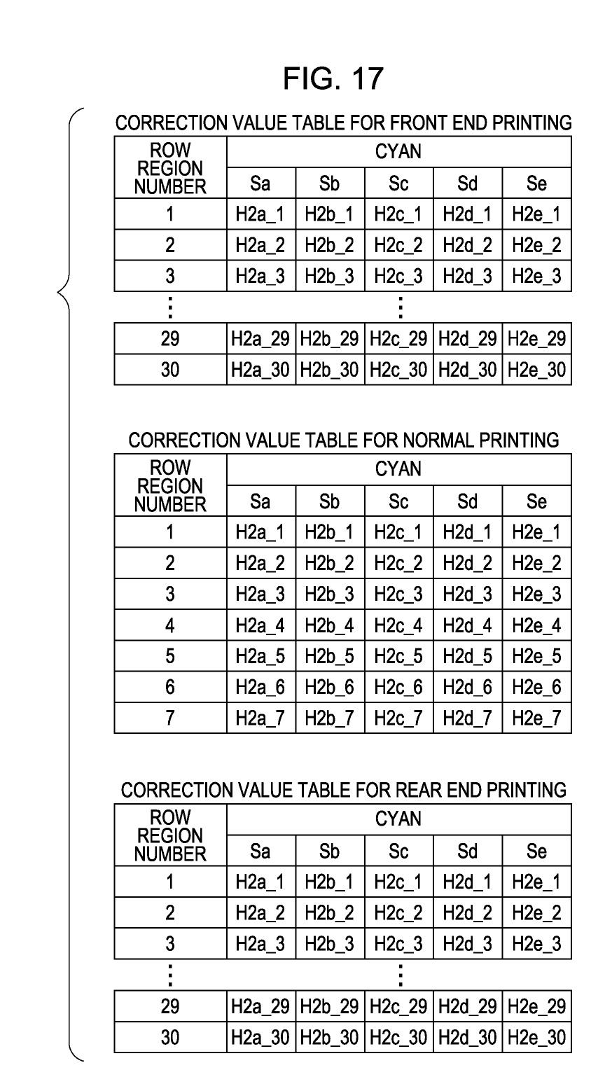

FIG. 17 is a second correction value table. The second correction value H2 is stored in a memory 53 of the printer 1 after calculating the second correction value H2 by a correction value obtaining program. There are three kinds of second correction value tables for front end printing, normal printing, and rear end printing. In each correction value table, five correction values (H2a_i, H2b_i, H2c_i, H2d_i, H2e_i) with respect to five command gray-scale values are matched with each other for every row region i.

### <Regarding Printing by a User>

After the second correction value H2 for density unevenness correction is calculated and the second correction value H2 is stored in the memory 53 of the printer in a manufacturing process of the printer 1, the printer 1 is shipped. Then, when a user installs a printer driver to use the printer 1, the printer driver requests the printer 1 to transmit the second correction value H2 stored in the memory 53 to the computer 60. The printer driver stores the second correction value H2 transmitted from the printer 1 in the memory within the computer 60. Then, when the printer driver receives a printing instruction from the user, the printer driver creates print data and transmits the print data to the printer 1. The printer driver creates the print data according to the print data creation processing of FIG. 5 and performs printing (equivalent to a liquid ejecting method).

Here, density correction processing (S003 of FIG. 5) in the print data creation processing will be described. As the density correction processing, the printer driver corrects a gray-scale value (hereinafter, referred to as a gray-scale value S_in before correction) of each pixel data, the gray-scale value (S_in), on the basis of the second correction value H2 of the row region to which the pixel data corresponds (referred to as a gray-scale value S_out after correction). In addition, since there are regularities for every seven row regions in normal printing, it is preferable to perform the density correction processing by repeatedly using seven correction values H in order for every seven row regions of approximately thousands of row regions.

If the gray-scale value S_in before correction is the same as any one of the command gray-scale values Sa, Sb, Sc, Sd, and Se, the second correction values H2a, H2b, H2c, H2d, and H2e stored in the memory of the computer 60 can be used as they are. For example, if the gray-scale value S_in before correction is equal to Sc, the gray-scale value S_out after correction is calculated by the following expression.

S_out=Sc×(1+H2c)

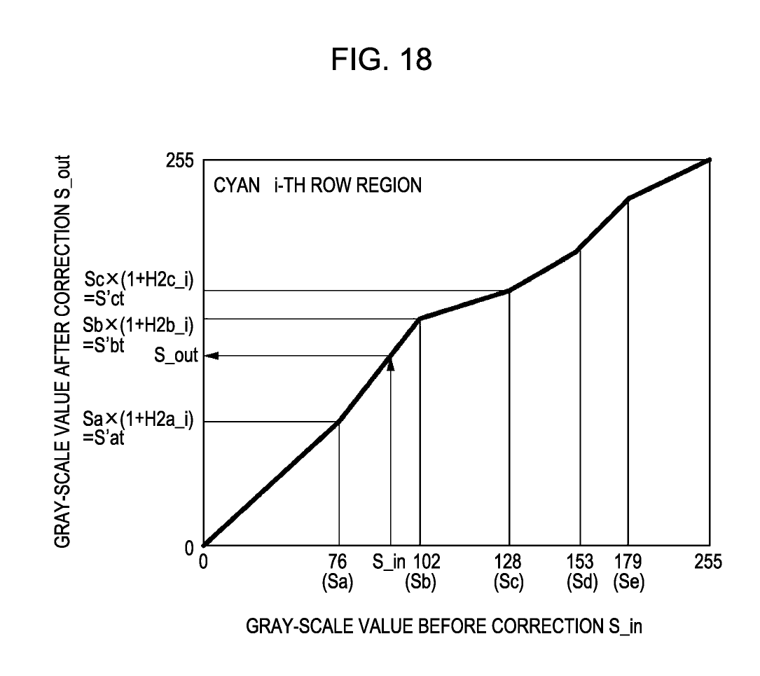

FIG. 18 is a view showing a correction method when the gray-scale value S_in before correction of the i-th row region of cyan is different from a command gray-scale value. A horizontal axis indicates the gray-scale value S_in before correction, and a vertical axis indicates the gray-scale value S_out after correction. When the gray-scale value S_in before correction is between the command gray-scale values Sa and Sb, the gray-scale value S_out after correction is calculated by linear interpolation based on the second correction value H2a of the command gray-scale value Sa and the correction value H2b of the command gray-scale value Sb by the following expression.

S_out=Sa+(S′bt−S′at)×{(S_in−Sa)/(Sb−Sa)}

In addition, when the gray-scale value S_in before correction is smaller than the command gray-scale value Sa, the gray-scale value S_out after correction is calculated by linear interpolation of a gray-scale value 0 (minimum gray-scale value) and the command gray-scale value Sa. When the gray-scale value S_in before correction is larger than the command gray-scale value Se, the gray-scale value S_out after correction is calculated by linear interpolation of a gray-scale value 255 (maximum gray-scale value) and the command gray-scale value Se.

In addition, it may be possible to calculate a second correction value H2_out corresponding to the gray-scale value S_in before correction different from the command gray-scale value and calculate the gray-scale value S_out after correction without being limited thereto (S_out=S_in×(1+H2_out)).

### Calculation of a Density Unevenness Correction Value

### Second Example

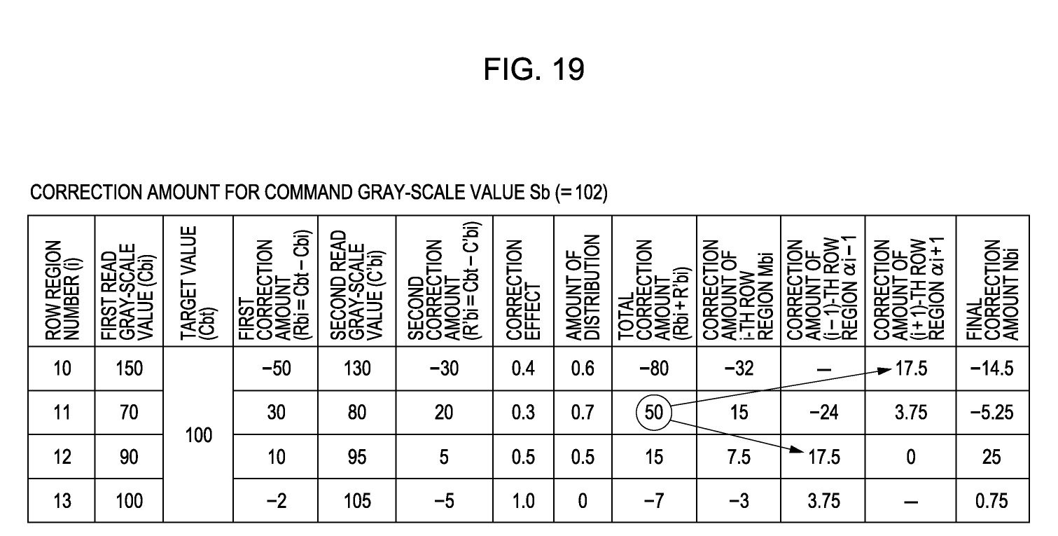

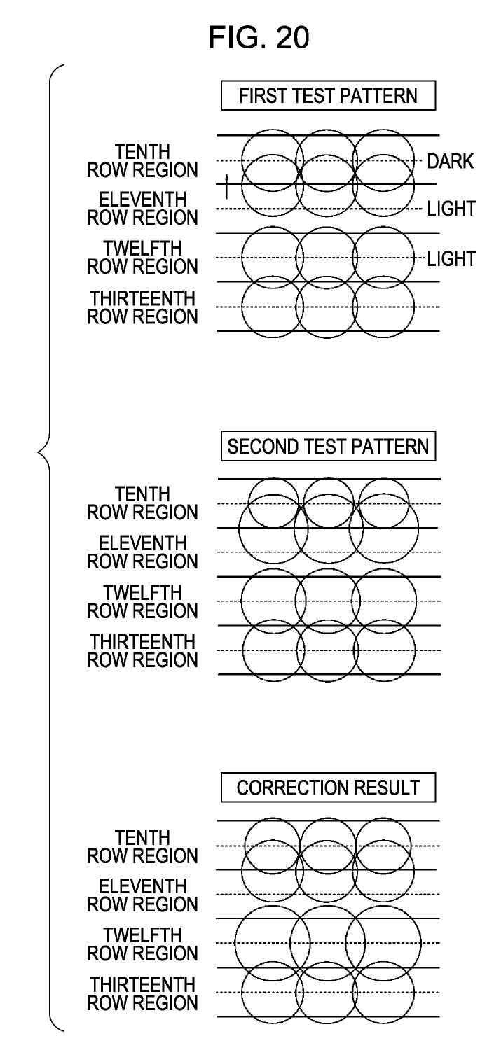

FIG. 19 is a view showing a specific calculation value of a second correction value in a second example, and FIG. 20 is a view showing first and second test pattern results and a result of density unevenness correction using the second correction value H2, which are based on values of FIG. 19. In addition, processing for printing a second test pattern and obtaining a second read gray-scale value and processing after calculating the second correction value H2 are assumed to be similar to those in the first example.

In the first example described above, when the correction effects of the second test pattern result obtained by performing density correction processing using the first correction value H1 are not sufficient, a predetermined amount (10%) of the correction amount of the row region is distributed to adjacent regions for all row regions where the correction effects are not sufficient. On the other hand, in this second example, the correction effects of the first correction value H1 are calculated for every row region, and the correction amount distributed to adjacent row regions are determined on the basis of the correction effects.

A specific example is shown below. As shown in FIG. 20, dots of an eleventh row region are deflected in flight to lean to a tenth row region, such that the tenth row region is viewed dark and the eleventh row region is viewed light. Accordingly, in a second test pattern on which density correction processing was performed by the first correction value H1, dots of the tenth row region become small and dots of the eleventh row region become large. However, the dots of the eleventh row region are deflected in flight. Accordingly, as can be seen from the second correction amount R′bi of FIG. 20, the correction effects are not sufficient in the correction using the first correction amount H1.

Here, in the second example, the correction effects of the first correction value H1 are calculated by the following expression. The correction effects of the first correction value H1 are calculated on the basis of a difference between the correction amount (first correction amount Rbi) when density correction processing is not performed and the correction amount (second correction amount R′bi) when the density correction processing was performed using the first correction value H1. That is, on the basis of the target value Cbt (equivalent to a target read gray-scale value), the first read gray-scale value, and the second read gray-scale value, the correction effects of the first correction value are calculated for every row region (pixel row).

Correction effects=(first correction amount Rbi−second correction amount R′bi)/first correction amount Rbi

It can be said that density correction of the row region can be performed further by nozzles corresponding to the row region as the correction effects increase. On the contrary, low correction effects mean that nozzles corresponding to the row region are deflected in flight or are influenced by adjacent row regions. Therefore, it is necessary to further complement the density correction of the row region with the adjacent row region. That is, the correction amount distributed to the adjacent row region changes with the correction effects.

When calculating the second correction value H2 of a certain row region, a rate of correction effects of the first correction value of the total correction amount (Rbi+R′bi) is set as the correction amount of the row region. In addition, a rate in which there were no correction effects based on the first correction value of the total correction amount is uniformly distributed to adjacent row regions.

Specifically, when values of the table of FIG. 19 are used, the correction effects of the eleventh row region are calculated by the following expression.

Correction effects=(first correction amount Rbi−second correction amount R′bi)/first correction amount Rbi=(30−20)/30=0.33 . . . ≅0.3

Since the correction effects based on the first correction value H1 of the eleventh row region are 30%, the correction amount of 30% of the total correction amount (30+20=50) is assigned to the eleventh row region and the correction amount of 70% of the total correction amount is distributed to the adjacent row regions. That is, the correction amount 17.5 (=50×0.7×0.5) is distributed to each of the tenth and twelfth row regions.

In this way, the correction effects of the first correction value H1 is calculated sequentially from the first row region and the correction amount distributed to row regions adjacent to each row region is determined. In addition, the final correction amount Nbi of each row region is calculated. For example, the final correction amount Nbi=−5.25 of the eleventh row region becomes a total correction amount of the correction amount 15 (=50×0.3) of the row region, the correction amount −24 (=−80×0.6×0.5) distributed from the tenth row region, and the correction amount 3.75 (=15×0.5×0.5) distributed from the twelfth row region. Accordingly, in a result of final correction using the second correction value H2, the dot diameter becomes slightly small in dots of the eleventh row region.

Since the eleventh row region is viewed light as a result of the first test pattern, the dots are large in the second test pattern. However, since dots of the eleventh row region are formed to lean to the tenth row region, the effects of density correction based on making dots of the eleventh row region large are reduced (30%). Then, the correction amount of the eleventh row region is distributed more to adjacent row regions (70%). As a result, since the dots of the twelfth row region become large, the density of the eleventh row region is complemented.

Moreover, in the result of the second test pattern, the correction effects of the tenth row region are also small due to an influence of size increase in dots of the eleventh row region deflected in flight (40%). Therefore, a large part of the correction amount of the tenth row region is distributed to ninth (not shown) and eleventh row regions (60%). As a result, it can be suppressed that the dots of the eleventh row region become large, and it can be prevented that the correction effects for making the tenth row region light are reduced.

For example, in a row region corresponding to nozzles largely deflected in flight and a row region corresponding to nozzles that are seldom deflected in flight, the correction effects by nozzles corresponding to the row region are different. Therefore, the density unevenness can be reduced more in the case where the rate of correction amount distributed to adjacent row region is determined on the basis of the correction effects using nozzles corresponding to the row region than in the case where the same rate of correction amount is distributed to adjacent row regions for all row regions where the correction effects are not sufficient like the first example. However, in the second example, the processing time becomes long as much as a portion while correction effects using the first correction value H1 are calculated, compared with the first example.

### Calculation of a Density Unevenness Correction Value

### Third Example

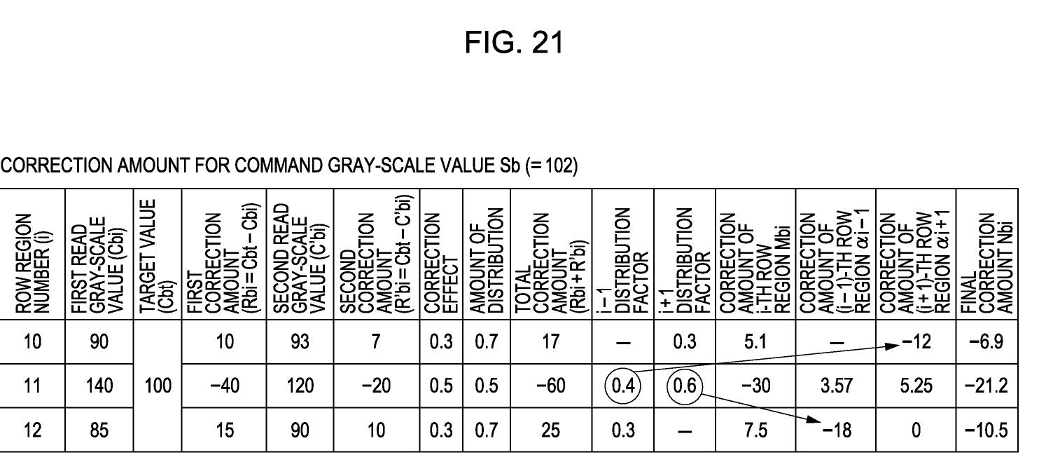

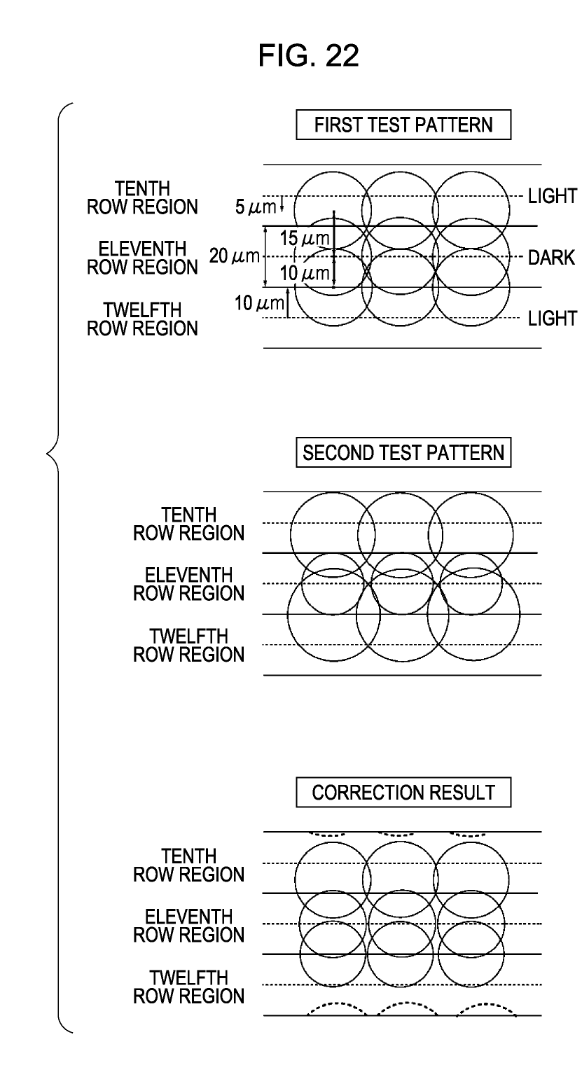

FIG. 21 is a view showing a specific calculation value of a second correction value in a third example, and FIG. 22 is a view showing first and second test pattern results and a result of density unevenness correction using the second correction value H2, which are based on values of FIG. 21. In addition, processing until a second test pattern is printed and the correction effects of the first correction value H1 are calculated and processing after calculating the second correction value H2 are assumed to be similar to those in the second example.

In the second example, the correction amount that cannot be corrected with nozzles corresponding to the row region is uniformly distributed to adjacent row regions. On the other hand, in the third example, the correction amount distributed to adjacent row region is made to change on the basis of flight deflection information. Flight deflection information is data obtained by checking the amount of ink ejected from each nozzle, which is deflected in flight, at the time of head manufacture and the like. This flight deflection information is stored in the memory 13 of the printer 1 at the time of printer manufacture and is used when the computer 60 obtains a correction value according to the correction value obtaining program.

As shown in FIG. 22, dots of the tenth row region are formed to lean by 5 μm to the eleventh row region, and dots of the twelfth row region are formed to lean by 10 μm to the eleventh row region. In such a case, the eleventh row region is viewed dark and the tenth and twelfth row regions are viewed light. Since the first correction value H1 performs density correction only by nozzles corresponding to the row region, dots formed in the eleventh row region become small in the result of the second test pattern. Accordingly, dots formed in the tenth and twelfth row regions become large.

However, since the dots formed in the tenth and twelfth row regions are deflected in flight, the effects of density correction are small even if the density of the row region is increased by making the dots large. Moreover, if dots of the tenth and twelfth row regions are made too large, the effects of density correction of the eleventh row region to be corrected light are reduced. As a result, as shown in FIG. 21, the correction effects of the first correction value H1 of the tenth row region are 30%, the correction effects of the eleventh row region are 50%, and the correction effects of the twelfth row region are 30%.

Moreover, in the third example, when the correction amount (−60×(1−0.5)), by which correction cannot be performed in the row region, of the total correction amount (−60) of the eleventh row region is distributed to adjacent row regions, flight deflection information of the tenth and twelfth row regions is used. Since dots formed to lean more to the eleventh row region have larger effects on the density of the eleventh row region, the correction amount of the eleventh row region is distributed more thereto. Calculation expressions of a distribution factor of the tenth row region ((i−1)-th row region) and the twelfth row region ((i+1)-th row region) in the distributed correction amount of the eleventh row region (i-th row region) are shown below.

Distribution factor of (i−1)-th row region=(distance between the center of i-th row and dot of (i+1)−th row region)/(dot distance between (i−1)-th row region and (i+1)-th row region)

Distribution factor of (i+1)-th row region=(distance between the center of i-th row and dot of (i−1)-th row region)/(dot distance between (i−1)-th row region and (i+1)-th row region)

When they are expressed as specific values, a distance between a dot of the tenth row region and the center of the eleventh row region is 15 μm, a distance between the center of the eleventh row region and a dot of the twelfth row region is 10 μm, and a dot distance between the tenth and twelfth row regions is 25 μm. Accordingly, the distribution factor of the tenth row region is set to 0.4 (=10/25). The distribution factor of the twelfth row region is set to 0.6 (=15/25). Thus, since dots of the twelfth row region are closer to the eleventh row region than dots of the tenth row region are, the distribution factor for the twelfth row region is higher than the distribution factor of the tenth row region.

In the final correction result based on the second correction value, dots (final correction amount=−10.5) of the twelfth row region become smaller than dots (final correction amount=−6.9) of the tenth row region. Thus, since dots of the twelfth row region have larger effects on the eleventh row region, the eleventh row region can be made light by making the dots of the twelfth row region smaller than dots of the tenth row region. In addition, although the tenth and twelfth row regions should be made dark, the dots are small. However, by distributing the correction amount to a ninth or thirteenth row region (dotted portion) to complement the density of the tenth or twelfth row region, the density unevenness is improved.

That is, in the third example, a distance between landing positions of liquid droplets, which are ejected from nozzles corresponding to a row region adjacent to one side of a certain row region (corresponding to a pixel row), and the row region is compared with a distance between landing positions of liquid droplets, which are ejected from nozzles corresponding to a row region adjacent to the other side of the row region, and the row region and the correction amount is distributed more to the adjacent row region corresponding to the shorter distance (shorter one). Thus, it is determined which row region of two adjacent row regions has a larger effect on the row region on the basis of flight deflection information at the time of head manufacture. In addition, the density unevenness is further improved by distributing a large part of the correction amount of the row region to an adjacent row region that has a larger effect on the row region.

### Other Embodiments

Although the printing system having an ink jet printer is mainly described in each of the above-described embodiments, disclosure of a density unevenness correcting method and the like is included. In addition, the above-described embodiments are to make the present invention easily understood and are not intended to limit the present invention. It is needless to say that various modifications and changes may be made without departing from the spirit and scope of the present invention and the equivalents are included in the present invention. Particularly embodiments described below are also included in the present invention.

### <Regarding a Line Head Printer>

In the above-described embodiment, the serial type printer that alternately repeats an operation of forming a raster line while a head moves in the moving direction and an operation of transporting paper is mentioned as an example. However, the present invention is not limited thereto. For example, the present invention is also applied to a line head printer in which nozzles are arrayed in the paper width direction and an image is completed by ejecting ink onto paper transported below the nozzles without being stopped in the transport direction. In this case, a raster line is formed along the transport direction and a correction pattern is formed by a plurality of raster lines arrayed in the paper width direction. In addition, the row region indicates a region formed by a plurality of pixel regions arrayed in the transport direction. A row region where correction using the first correction value H1 is not sufficient distributes the correction amount of the row region to row regions adjacent thereto in the paper width direction.

In the case of the line head printer, nozzles of raster lines arrayed in the paper width direction do not change. Accordingly, it is not necessary to calculate a correction value for every printing method (normal printing front end and rear end printing) unlike the above-described interlace printing. However, even in the case of the line head printer, when there are plural nozzle rows arrayed in the paper width direction and raster lines are formed using the plurality of nozzle rows every fixed distance, nozzles that form adjacent raster lines change according to the location. Therefore, it is preferable to form a test pattern in consideration of the point.

### <Regarding Band Printing>

In band printing, when a band image formed in the one-time moving direction (pass) of a head is printed, paper is transported by the band image and printing is performed such that band images are arrayed in the transport direction. That is, in the band printing, raster lines formed in other paths are not printed between raster lines formed in certain paths. That is, nozzles corresponding to adjacent row regions are always the same. Accordingly, there is no need of calculating a correction value for every printing method unlike the above-described embodiment. When correction using only nozzles corresponding to the row region is not sufficient, the density unevenness can be further reduced by distributing the correction amount of the row region to adjacent row regions.

### <Regarding Overlap Printing>

Overlap printing is a printing method in which one raster line is formed by two or more nozzles. For example, in the serial type printer like the above-described embodiment, a first raster line is formed in a row region along the moving direction by a nozzle #1 and a nozzle #90 and a second raster line is formed by a nozzle #2 and a nozzle #91 so as to be adjacent to an upstream side of the first raster line in the transport direction. Even if the raster lines are formed by the plurality of nozzles as described above, a correction value is calculated for every row region in order to correct the density difference (density unevenness) between row regions. At this time, the density unevenness can be further reduced by distributing the correction amount of the row region to adjacent row regions.

### <Regarding a Liquid Ejecting Device>

In the above-described embodiment, the ink jet printer was illustrated as a liquid ejecting device (portion) that executes a liquid ejecting method. However, the present invention is not limited thereto. The present invention may be applied not only to the printer (printing apparatus) but also to various industrial apparatuses as long as they are liquid ejecting devices. For example, the present invention may also be applied to a textile printing apparatus for decorating a cloth with a pattern, a color filter manufacturing apparatus or a display manufacturing apparatus such as an organic EL display, a DNA chip manufacturing apparatus that manufactures a DNA chip by applying to a chip a solution with a melted DNA, a circuit board manufacturing apparatus, and the like.

In addition, the liquid ejecting method may be a piezoelectric method of ejecting liquid by applying a voltage to a driving element (piezoelectric element) to expand and contract an ink chamber or may be a thermal method of generating bubbles in a nozzle using a heating device and ejecting liquid with the bubbles.

1. A method for obtaining a correction value, comprising: a step of forming a first test pattern configured to include a plurality of pixel rows, each of which has a plurality of pixels arrayed in a predetermined direction, arrayed in a direction crossing the predetermined direction; a step of obtaining a first read gray-scale value for every pixel row by making a scanner read the first test pattern; a step of calculating a first correction value for every pixel row on the basis of the first read gray-scale value; a step of forming a second test pattern, which is configured to include the pixel rows arrayed in the crossing direction, using the first correction value; a step of obtaining a second read gray-scale value for every pixel row by making the scanner read the second test pattern; a step of calculating a correction amount for every pixel row on the basis of the first read gray-scale value and the second read gray-scale value; and a step of calculating a second correction value of the certain pixel row on the basis of the correction amount of the pixel row and the correction amount of the pixel row adjacent to the pixel row.

2. The method for obtaining a correction value according to claim 1,
wherein in the step of calculating the second correction value, a part of the correction amount of each of the pixel rows is distributed to an adjacent pixel row adjacent to each of the pixel rows, and the second correction value of the pixel row is calculated on the basis of the correction amount obtained by adding the correction amount of the certain pixel row and the correction amount distributed from the adjacent pixel row.

3. The method for obtaining a correction value according to claim 2,
wherein correction effects of the first correction value are calculated for every pixel row on the basis of a target read gray-scale value, the first read gray-scale value, and the second read gray-scale value of the pixel row, and
the correction amount distributed to the adjacent pixel row changes with the correction effects.

4. The method for obtaining a correction value according to claim 2 or 3,
wherein a distance between landing positions of liquid droplets, which are ejected from nozzles corresponding to the adjacent pixel row adjacent to one side of the certain pixel row, and the pixel row is compared with a distance between landing positions of liquid droplets, which are ejected from nozzles corresponding to the adjacent pixel row adjacent to the other side of the pixel row, and the pixel row, and
the correction amount is distributed more to the adjacent pixel row corresponding to the shorter distance.

5. A liquid ejecting device,
wherein a correction value is stored,
a gray-scale value expressed by a pixel of image data to be printed is corrected by the correction value and liquid is ejected on the basis of the corrected gray-scale value, and
the correction value is obtained by:
forming a first test pattern configured to include a plurality of pixel rows, each of which has a plurality of pixels arrayed in a predetermined direction, arrayed in a direction crossing the predetermined direction;
obtaining a first read gray-scale value for every pixel row by making a scanner read the first test pattern;
calculating a first correction value for every pixel row on the basis of the first read gray-scale value;
forming a second test pattern, which is configured to include the pixel rows arrayed in the crossing direction, using the first correction value;
obtaining a second read gray-scale value for every pixel row by making the scanner read the second test pattern;
a step of calculating a correction amount for every pixel row on the basis of the first read gray-scale value and the second read gray-scale value; and
a step of calculating a second correction value of the certain pixel row on the basis of the correction amount of the pixel row and the correction amount of the pixel row adjacent to the pixel row.
